(19) United States
(12) Patent Application Publication
(10) Pub. No.: US 2024/0015714 A1
(43) Pub. Date: Jan. 11, 2024

(54) RESOURCE ALLOCATION FOR FREQUENCY DIVISION MULTIPLEXING UPLINK SHARED CHANNEL CONFIGURATIONS

(71) Applicant: QUALCOMM Incorporated, San Diego, CA (US)

(72) Inventors: Mostafa KHOSHNEVISAN, San Diego, CA (US); Yitao CHEN, San Diego, CA (US); Xiaoxia ZHANG, San Diego, CA (US)

(21) Appl. No.: 18/307,660

(22) Filed: Apr. 26, 2023

Related U.S. Application Data
(60) Provisional application No. 63/367,258, filed on Jun. 29, 2022.

(51) Int. Cl. H04W 72/0453; H04W 72/232; H04L 5/00

(52) U.S. Cl. CPC H04W 72/0453; H04W 72/232; H04L 5/0012

(57) ABSTRACT

Various aspects of the present disclosure generally relate to wireless communication. In some aspects, a user equipment (UE) may receive a frequency division multiplexing (FDM) uplink shared channel configuration associated with a resource block (RB) partitioning scheme for partitioning a set of allocated RBs into a first subset of RBs and a second subset of RBs, wherein the second subset of RBs is associated with an RB offset corresponding to a first starting RB, the first starting RB comprising an RB of the first subset of RBs having a lowest frequency value of a plurality of frequency values corresponding to the first subset of RBs. The UE may transmit an uplink shared channel signal based at least in part on the FDM uplink shared channel configuration. Numerous other aspects are described.

### CROSS-REFERENCE TO RELATED APPLICATION

This Patent Application claims priority to U.S. Provisional Patent Application No. 63/367,258, filed on Jun. 29, 2022, entitled “RESOURCE ALLOCATION FOR FREQUENCY DIVISION MULTIPLEXING UPLINK SHARED CHANNEL CONFIGURATIONS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for resource allocation for frequency division multiplexing uplink shared channel configurations.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a frequency division multiplexing (FDM) uplink shared channel configuration associated with a resource block (RB) partitioning scheme for partitioning a set of allocated RBs into a first subset of RBs and a second subset of RBs, wherein the second subset of RBs is associated with an RB offset corresponding to a first starting RB, the first starting RB comprising an RB of the first subset of RBs having a lowest frequency value of a plurality of frequency values corresponding to the first subset of RBs. The method may include transmitting an uplink shared channel signal based at least in part on the FDM uplink shared channel configuration.

Some aspects described herein relate to a method of wireless communication performed by a network node. The method may include transmitting an FDM uplink shared channel configuration associated with an RB partitioning scheme for partitioning a set of allocated RBs into a first subset of RBs and a second subset of RBs, wherein the second subset of RBs is associated with an RB offset corresponding to a first starting RB, the first starting RB comprising an RB of the first subset of RBs having a lowest frequency value of a plurality of frequency values corresponding to the first subset of RBs. The method may include receiving an uplink shared channel signal based at least in part on the FDM uplink shared channel configuration.

Some aspects described herein relate to a UE for wireless communication. The UE may include a memory and one or more processors coupled to the memory. The one or more processors may be configured to cause the UE to receive an FDM uplink shared channel configuration associated with an RB partitioning scheme for partitioning a set of allocated RBs into a first subset of RBs and a second subset of RBs, wherein the second subset of RBs is associated with an RB offset corresponding to a first starting RB, the first starting RB comprising an RB of the first subset of RBs having a lowest frequency value of a plurality of frequency values corresponding to the first subset of RBs. The one or more processors may be configured to cause the UE to transmit an uplink shared channel signal based at least in part on the FDM uplink shared channel configuration.

Some aspects described herein relate to a network node for wireless communication. The network node may include a memory and one or more processors coupled to the memory. The one or more processors may be configured to cause the network node to transmit an FDM uplink shared channel configuration associated with an RB partitioning scheme for partitioning a set of allocated RBs into a first subset of RBs and a second subset of RBs, wherein the second subset of RBs is associated with an RB offset corresponding to a first starting RB, the first starting RB comprising an RB of the first subset of RBs having a lowest frequency value of a plurality of frequency values corresponding to the first subset of RBs. The one or more processors may be configured to cause the network node to receive an uplink shared channel signal based at least in part on the FDM uplink shared channel configuration.

Some aspects described herein relate to a non-transitory computer-readable medium that stores a set of instructions for wireless communication by a UE. The set of instructions, when executed by one or more processors of the UE, may cause the UE to receive an FDM uplink shared channel configuration associated with an RB partitioning scheme for partitioning a set of allocated RBs into a first subset of RBs and a second subset of RBs, wherein the second subset of RBs is associated with an RB offset corresponding to a first starting RB, the first starting RB comprising an RB of the first subset of RBs having a lowest frequency value of a plurality of frequency values corresponding to the first subset of RBs. The set of instructions, when executed by one or more processors of the UE, may cause the UE to transmit an uplink shared channel signal based at least in part on the FDM uplink shared channel configuration.

Some aspects described herein relate to a non-transitory computer-readable medium that stores a set of instructions for wireless communication by a network node. The set of instructions, when executed by one or more processors of the network node, may cause the network node to transmit an FDM uplink shared channel configuration associated with an RB partitioning scheme for partitioning a set of allocated RBs into a first subset of RBs and a second subset of RBs, wherein the second subset of RBs is associated with an RB offset corresponding to a first starting RB, the first starting RB comprising an RB of the first subset of RBs having a lowest frequency value of a plurality of frequency values corresponding to the first subset of RBs. The set of instructions, when executed by one or more processors of the network node, may cause the network node to receive an uplink shared channel signal based at least in part on the FDM uplink shared channel configuration.

Some aspects described herein relate to an apparatus for wireless communication. The apparatus may include means for receiving an FDM uplink shared channel configuration associated with an RB partitioning scheme for partitioning a set of allocated RBs into a first subset of RBs and a second subset of RBs, wherein the second subset of RBs is associated with an RB offset corresponding to a first starting RB, the first starting RB comprising an RB of the first subset of RBs having a lowest frequency value of a plurality of frequency values corresponding to the first subset of RBs. The apparatus may include means for transmitting an uplink shared channel signal based at least in part on the FDM uplink shared channel configuration.

Some aspects described herein relate to an apparatus for wireless communication. The apparatus may include means for transmitting an FDM uplink shared channel configuration associated with an RB partitioning scheme for partitioning a set of allocated RBs into a first subset of RBs and a second subset of RBs, wherein the second subset of RBs is associated with an RB offset corresponding to a first starting RB, the first starting RB comprising an RB of the first subset of RBs having a lowest frequency value of a plurality of frequency values corresponding to the first subset of RBs. The apparatus may include means for receiving an uplink shared channel signal based at least in part on the FDM uplink shared channel configuration.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of single-downlink control information (DCI)-based multiple transmission reception point (mTRP) operation, in accordance with the present disclosure.

FIG. 5 is a diagram of an example associated with resource allocation for frequency division multiplexing (FDM) uplink shared channel configurations, in accordance with the present disclosure.

FIG. 6 is a diagram of an example associated with resource allocation for FDM uplink shared channel configurations, in accordance with the present disclosure.

FIG. 7 is a diagram of an example associated with resource allocation for FDM uplink shared channel configurations, in accordance with the present disclosure.

FIG. 8 is a diagram illustrating an example process performed, for example, by a UE, in accordance with the present disclosure.

FIG. 9 is a diagram illustrating an example process performed, for example, by a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

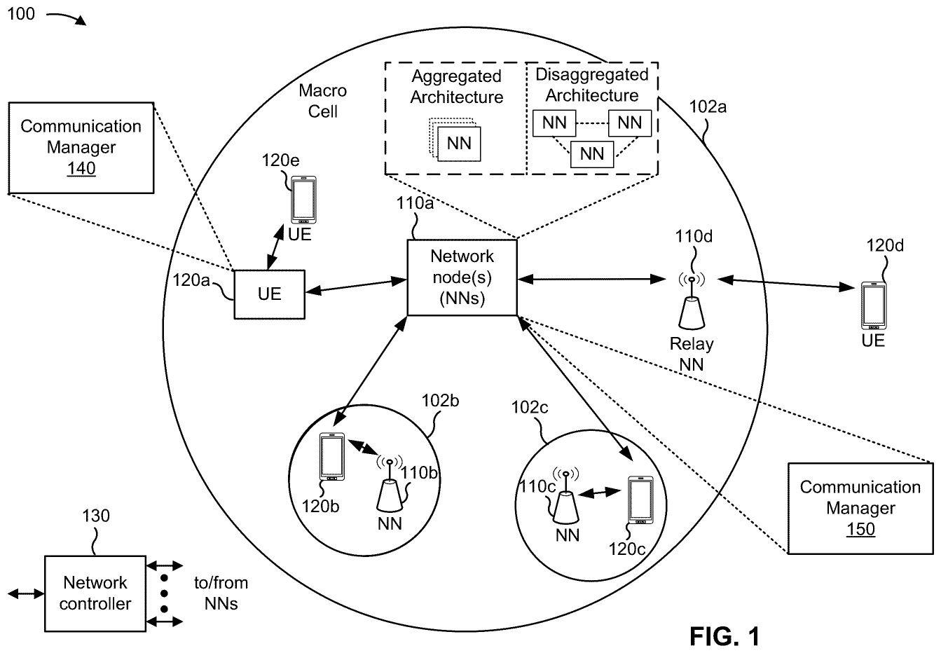

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the communication manager 140 may receive a frequency division multiplexing (FDM) uplink shared channel configuration associated with a resource block (RB) partitioning scheme for partitioning a set of allocated RBs into a first subset of RBs and a second subset of RBs, wherein the second subset of RBs is associated with an RB offset corresponding to a first starting RB, the first starting RB comprising an RB of the first subset of RBs having a lowest frequency value of a plurality of frequency values corresponding to the first subset of RBs; and transmit an uplink shared channel signal based at least in part on the FDM uplink shared channel configuration. Additionally, or alternatively, the communication manager 140 may perform one or more other operations described herein.

In some aspects, a network node (e.g., the network node 110) may include a communication manager 150. As described in more detail elsewhere herein, the communication manager 150 may transmit an FDM uplink shared channel configuration associated with an RB partitioning scheme for partitioning a set of allocated RBs into a first subset of RBs and a second subset of RBs, wherein the second subset of RBs is associated with an RB offset corresponding to a first starting RB, the first starting RB comprising an RB of the first subset of RBs having a lowest frequency value of a plurality of frequency values corresponding to the first subset of RBs; and receive an uplink shared channel signal based at least in part on the FDM uplink shared channel configuration. Additionally, or alternatively, the communication manager 150 may perform one or more other operations described herein.

As indicated above, FIG. 1 is provided as an example. Other examples may differ from what is described with regard to FIG. 1.

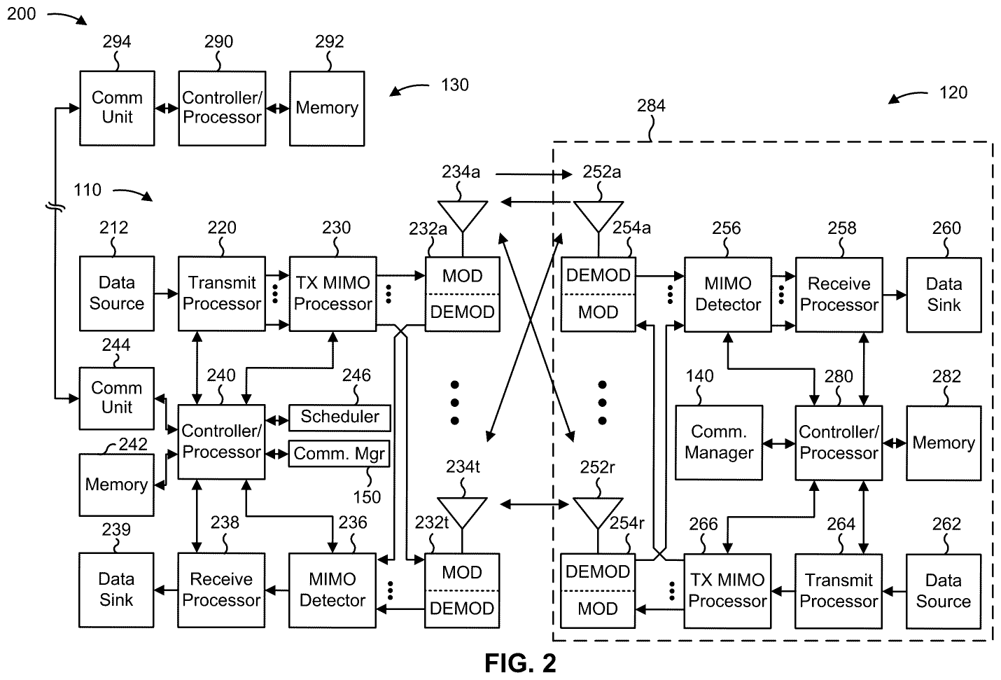

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving radio frequency signals. In some cases, the “sub-elements” also may be referred to as “antenna elements.” A single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a base station, such as for millimeter wave communications and/or the like. In such a case, the base station may provide the UE with a configuration of transmission configuration indicator (TCI) states that respectively indicate beams that may be used by the UE, such as for receiving a physical downlink shared channel (PDSCH). The base station may indicate an activated TCI state to the UE, which the UE may use to select a beam for receiving the PDSCH.

A beam indication may be, or include, a TCI state information element, a beam ID, spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a quasi-co-location (QCL) type (e.g., a qcl-Type1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a CSI-RS (e.g., an NZP-CSI-RS-ResourceId, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI. Wireless communications systems may support the use of various types of unified TCIs. For instance, a first type of unified TCI (e.g., Type 1 TCI) may be used to indicate a common beam for at least one downlink channel or reference signal and for at least one uplink channel or reference signal (e.g., a joint downlink uplink common TCI state). A second type of unified TCI (e.g., Type 2 TCI) may be used to indicate a common beam for more than one downlink channel or reference signal (e.g., a separate downlink common TCI state). A third type of unified TCI (e.g., Type 3 TCI) may be used to indicate a common beam for more than one uplink channel or reference signal (e.g., a separate uplink common TCI state). A fourth type of unified TCI (e.g., Type 4 TCI) may be used to indicate a beam for a single downlink channel or reference signal (e.g., a separate downlink single channel or reference signal TCI). A fifth type of unified TCI (e.g., Type 5 TCI) may be used to indicate a beam for a single uplink channel or reference signal (e.g., a separate uplink single channel or reference signal TCI). A sixth type of unified TCI (e.g., Type 6 TCI) may include uplink spatial relation information to indicate a beam for a single uplink channel or reference signal.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

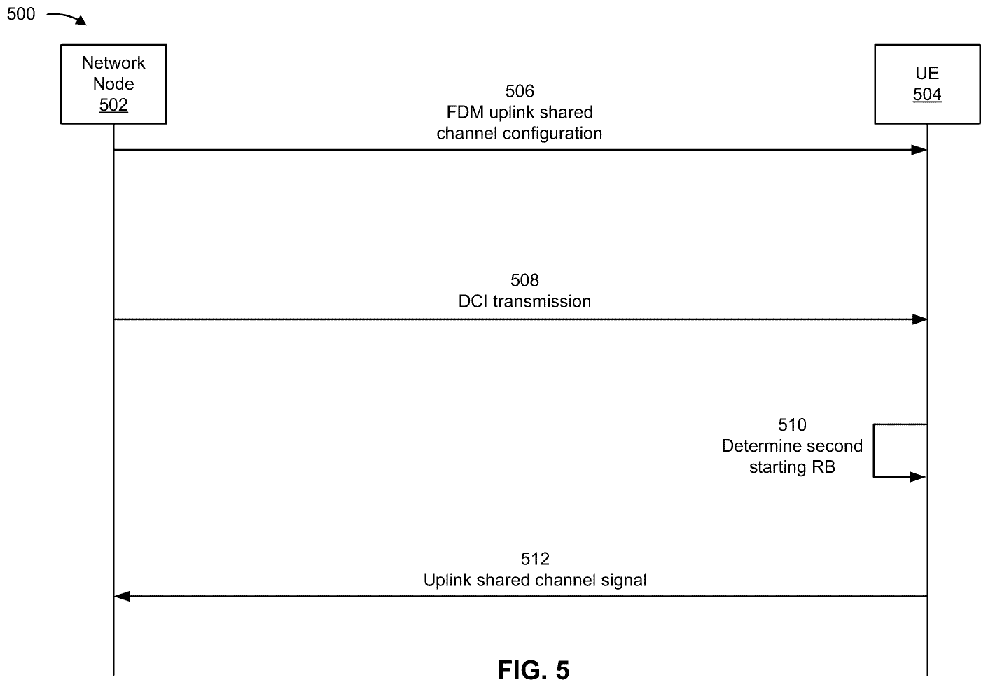

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-11).

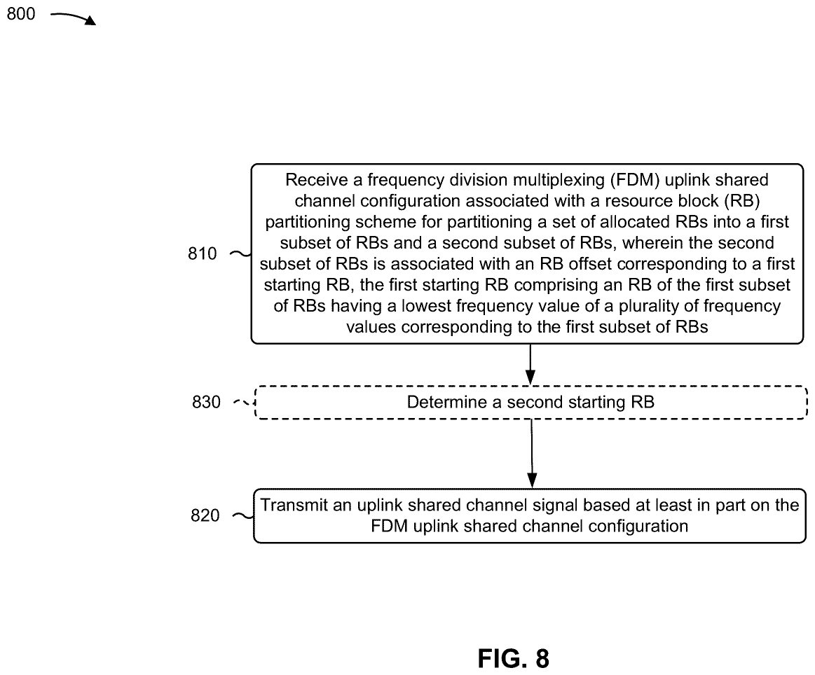

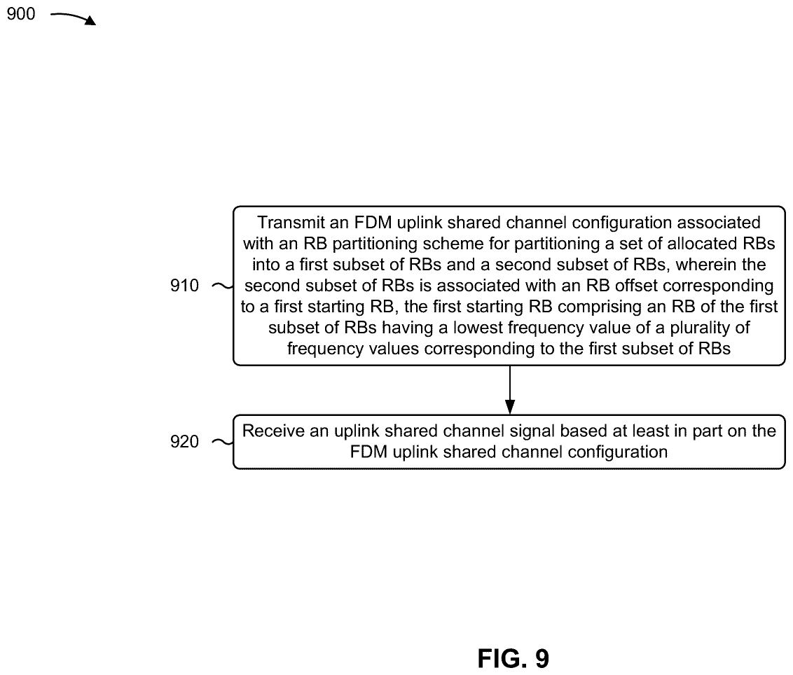

The controller/processor 240 of the network node 110, the controller/processor 280 of the UE 120, and/or any other component(s) of FIG. 2 may perform one or more techniques associated with resource allocation for FDM uplink shared channel configurations, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving an FDM uplink shared channel configuration associated with an RB partitioning scheme for partitioning a set of allocated RBs into a first subset of RBs and a second subset of RBs, wherein the second subset of RBs is associated with an RB offset corresponding to a first starting RB, the first starting RB comprising an RB of the first subset of RBs having a lowest frequency value of a plurality of frequency values corresponding to the first subset of RBs; and/or means for transmitting an uplink shared channel signal based at least in part on the FDM uplink shared channel configuration. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting an FDM uplink shared channel configuration associated with an RB partitioning scheme for partitioning a set of allocated RBs into a first subset of RBs and a second subset of RBs, wherein the second subset of RBs is associated with an RB offset corresponding to a first starting RB, the first starting RB comprising an RB of the first subset of RBs having a lowest frequency value of a plurality of frequency values corresponding to the first subset of RBs; and/or means for receiving an uplink shared channel signal based at least in part on the FDM uplink shared channel configuration. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

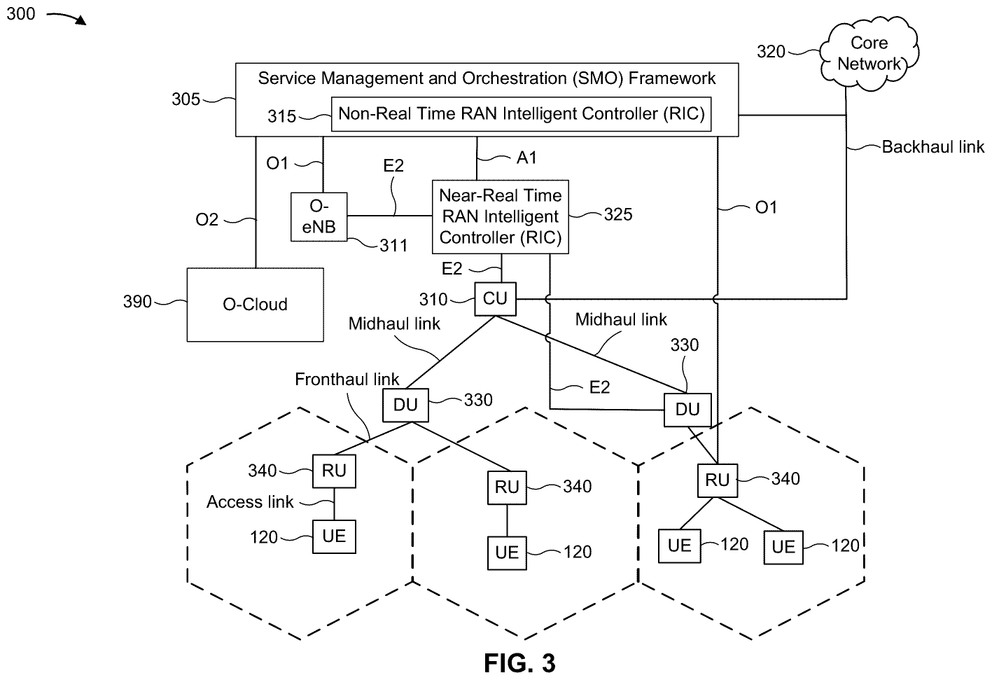

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

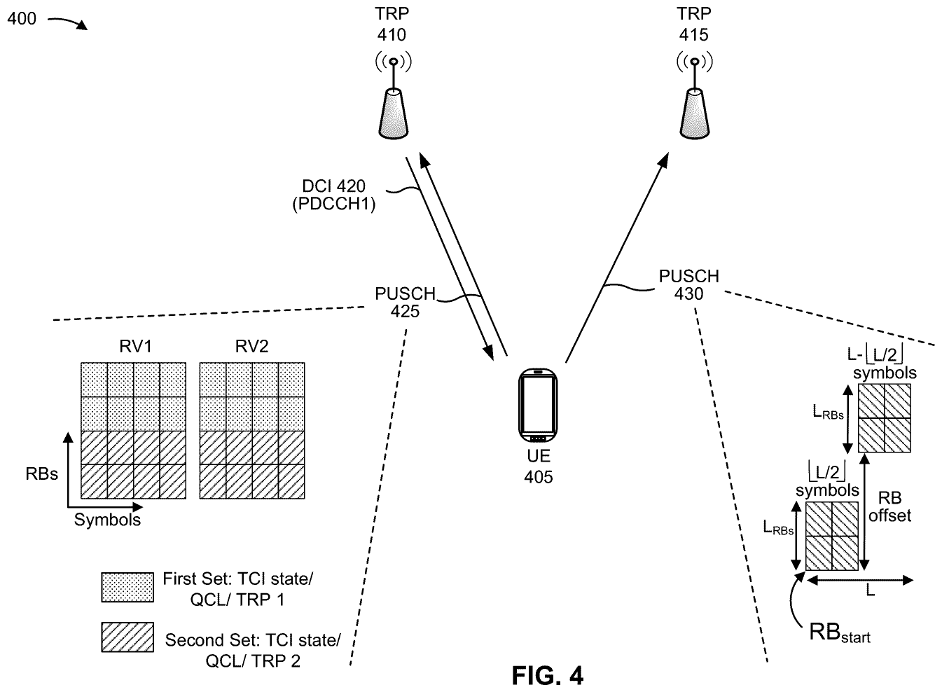

FIG. 4 is a diagram illustrating an example 400 of single-DCI-based multiple-transmission reception point (mTRP) operation, in accordance with the present disclosure. As shown, a UE 405 may communicate with a first TRP 410 and a second TRP 415. The UE 405 may be configured with single-DCI-based mTRP operation. In some aspects, the TRP 410 and/or the TRP 415 may be, include, or be included in, a one or more network nodes (e.g., one or more base stations 110 described above in connection with FIGS. 1 and 2). For example, different TRPs 410 and 415 may be included in different network nodes. In some cases, multiple TRPs 410 and 415 may be included in a single network node. In some cases, a TRP 410 and/or a TRP 415 may be referred to as a cell, a panel, an antenna array, or an array. The UE 405 may be, include, or be included in the UE 120 described above in connection with FIGS. 1 and 2.

Multiple TRPs 410 and 415 can transmit communications (for example, the same communication or different communications) in the same transmission time interval (TTI) (for example, a slot, a mini-slot, a subframe, or a symbol) or different TTIs using different QCL relationships (for example, different spatial parameters, different TCI states, different precoding parameters, or different beamforming parameters). A TCI state can be used to indicate one or more QCL relationships. A TRP 410 can be configured to individually (for example, using dynamic selection) or jointly (for example, using joint transmission with one or more other TRPs 410) serve traffic to the UE 405.

The UE 405 can be configured with single-DCI-based mTRP operation. As shown, when configured with single-DCI-based multi-TRP operation, the UE 405 can receive, from the TRP 410, a DCI transmission 420 in a first physical downlink control channel (PDCCH) transmission (shown as “PDCCH1”), where the DCI transmission 420 can schedule a first physical uplink shared channel (PUSCH) transmission 425 for transmitting to the first TRP 410. The DCI transmission 420 also can schedule a second PUSCH transmission 430 for transmitting to the second TRP 415. In some cases, the DCI transmission 420 can schedule one or more PDSCH transmissions in addition to, or in lieu of, the PUSCH transmissions. In association with a monitoring DCI transmitted from the first TRP 410, the UE 405 can monitor PDCCH candidates in PDCCH monitoring occasions in a quantity of different control resource sets (CORESETs), as configured by the network.

In some cases, the first TRP 410 can be associated with a serving cell of the UE 405. For example, the first TRP 410 can be a base station that provides the serving cell, or a relay device that provides access to the serving cell. In some cases, a quantity of additional TRPs may be associated with a quantity of additional serving cells. In some cases, the second TRP 415 can be associated with a non-serving cell. To communicate with a cell and receive a DCI transmission, the UE 405 can acquire beam indications for beam selection based on a TCI state. In some cases, synchronization signal block (SSB) information can be used to perform channel measurement, obtain TCI state, or select beams for communication. The UE 405 can obtain SSB transmission position, SSB transmission periodicity, and SSB transmission power associated with the cell and use that information to facilitate receiving and decoding a DCI transmission.

In some cases, the UE 405 can be configured to transmit communications using a single-DCI-based-PUSCH repetition in a time division multiplexing (TDM) manner. For example, a first set (shown as “first set”) of RBs can correspond to a first set of transmission parameters (beam/spatial relation/TCI state, power control, and/or precoding, shown as “TCI state/QCL/TRP 1”) and a second set (shown as “second set”) of RBs can correspond to a second set of transmission parameters (shown as “TCI state/QCL/TRP 2”). Different repetitions can be associated with the same transport block (TB). To achieve this, the two sets of repetitions can correspond to two SRS resource sets. For example, the DCI transmission 420 can indicate two beams and/or two sets of power control parameters using two corresponding SRS resource indicator (SRI) fields for both codebook-based and non-codebook-based PUSCH transmission. For codebook-based PUSCH transmission, there can be two transmission precoding matrix indicator (TPMI) fields to indicate two precoders for the two sets of repetitions.

In some cases, the UE 405 can transmit the first PUSCH transmission 425 and the second PUSCH transmission 430 simultaneously using FDM, as shown in FIG. 4 in connection with the first PUSCH transmission 425. For example, in single-DCI-based FDM PUSCH transmission, the DCI transmission 420 can schedule a PUSCH transmission (e.g., a combination of the PUSCH transmission 425 and the PUSCH transmission 430) for transmitting a set of RBs that is divided into two subsets of RBs (e.g., the first subset and the second subset) to be transmitted from two panels with different transmission beams, precoders, and/or power control parameters. The two subsets of RBs can be associated with two SRS resource sets. In a first scheme, a single repetition version (RV) can be transmitted using joint rate matching. In a second scheme, two different RVs (shown as “RV1” and “RV2”) can be transmitted using repetition and separate rate matching. The DCI transmission 420 can include an SRS resource set indicator field, two SRI fields, and two TPMI fields.

In some cases, the DCI transmission 420 can include a frequency domain resource allocation (FDRA) field that indicates a resource indication value (RIV) including a starting RB and/or RB group (RBG) and/or a number of consecutive RBs/RBGs. RBs can be contiguously allocated, and the RBG size can be configured by an RRC parameter, resourceAllocationType1Granularity. If not configured, the RBG size can be specified to be 1 (e.g., each RBG contains one RB). In a resource allocation (RA) type 1, the RIV indicates a starting RB and a number of RBs, and in an RA type 2, the RIV indicates a starting RBG and a number of RBGs.

In some cases, the UE 405 can use frequency hopping to transmit multiple subsets of a set of RBs, as shown in FIG. 4 in connection with the PUSCH transmission 430. For example, for PUSCH transmissions having a length L, the first └L/2┘ symbols of the repetition are transmitted in the first frequency hop, and the remaining L−└L/2┘ symbols of the repetition are transmitted in the second frequency hop. The starting RB, RBₛₜₐᵣₜ, can be determined by:

$${RB}_{start} = \{ \begin{matrix}{RB}_{start} & i = 0 \\ ( {RB}_{start} + {RB}_{offet} ) mod {N}_{BWP}^{size} & i = 1\end{matrix} ,$$

where RBₛₜₐᵣₜ is a value indicated in the FDRA field of the DCI transmission 420 for RA type 1. A list of frequency hopping offset values can be configured for the UE 405 that indicate a maximum of four RB values that can be used for RB_{offset}. If one value is included in the list, that value can be used for the second frequency hop. If two values are included in the list, the most significant bit (MSB) of the FDRA field can be used to indicate which frequency hopping offset value from the list are used for RB_{offset}, and the remaining bits can be used to indicate the starting RB and the number of RBs. If four values are included in the list, the two MSBs of the FDRA field can be used to indicate which frequency hopping offset value from the list are used for RB_{offset}, and the remaining bits can be used to indicate the starting RB and the number of RBs.

Whether to use frequency hopping or not can be dynamically indicated by an uplink DCI field of the DCI transmission 420. If the UL DCI field has a value of 1, the UE 405 can perform frequency hopping. Otherwise, UE does not perform frequency hopping. The frequency hopping offset list can be separately configured for different uplink DCI formats (e.g. for format 0_0 and 0_1 vs 0_2). However, for an FDM transmission scheme, some wireless communication standards do not provide a mechanism for transmitting two subsets of RBs that are offset from each other within the same symbols.

Some aspects of the techniques and apparatuses described herein may provide for transmitting two subsets of a set of RBs in an FDM manner, in which the two subsets of RBs are offset from one another in the frequency domain. In some aspects, the RBs are split between the two subsets in at least an approximately equal manner to increase the opportunity for a successful reception. For example, if one beam is blocked, roughly half of the coded bits may still be received by the network and may contain the transmitted communication. For example, in some aspects, the UE 405 may receive an FDM uplink shared channel configuration associated with an RB partitioning scheme for partitioning a set of allocated RBs into a first subset of RBs and a second subset of RBs. The second subset of RBs may be associated with an RB offset corresponding to a first starting RB. The first starting RB may be an RB of the first subset of RBs having a lowest frequency value of a plurality of frequency values corresponding to the first subset of RBs. The UE 405 may transmit an uplink shared channel signal (e.g., a PUSCH transmission) based at least in part on the FDM uplink shared channel configuration. In this way, some aspects may facilitate transmitting two offset subsets of RBs within the same symbols, thereby facilitating efficient and successful uplink communications. As a result, some aspects may positively impact network performance.

As indicated above, FIG. 4 is provided as an example. Other examples may differ from what is described with respect to FIG. 4.

FIG. 5 is a diagram of an example 500 associated with resource allocation for FDM uplink shared channel configurations, in accordance with the present disclosure. As shown in FIG. 5, a network node 502 (e.g., network node 110) may communicate with a UE 504 (e.g., UE 120). In some aspects, the network node 502 and the UE 504 may be part of a wireless network (e.g., wireless network 100). The UE 504 and the network node 502 may have established a wireless connection prior to operations shown in FIG. 5. In some aspects, the network node 502 and the UE 504 may be configured for FDM uplink shared channel communications. In some aspects, the network node 502 may be similar to, include, or be included in, the TRP 410 and/or the TRP 415 depicted in FIG. 4. In some aspects, the UE 504 may be, be similar to, include, or be included in, the UE 405 depicted in FIG. 4.

As shown by reference number 506, the network node 502 may transmit, and the UE 504 may receive, an FDM uplink shared channel configuration associated with an RB partitioning scheme for partitioning a set of allocated RBs into a first subset of RBs and a second subset of RBs. In some aspects, the second subset of RBs may be associated with an RB offset corresponding to a first starting RB. The first starting RB may include an RB of the first subset of RBs having a lowest frequency value of a plurality of frequency values corresponding to the first subset of RBs. In some aspects, the set of RBs may include a set of RBGs, the first subset of RBs may include a first subset of RBGs, and the second subset of RBs may include a second subset of RBGs.

As shown by reference number 508, the network node 502 may transmit, and the UE 504 may receive, a DCI transmission. The DCI transmission may include an FDRA field that indicates the set of RBs. In some aspects, the FDRA field may indicate the first starting RB and a first quantity of RBs included in the first subset of RBs. In some aspects, the second subset of RBs may include a second quantity of RBs (and/or RBGs) and the second quantity of RBs matches the first quantity of RBs. In some aspects, the second quantity of RBs may match the first quantity of RBs when a number of RBs and/or RBGs in the first subset of RBs is equal to, or at least approximately equal to, a number of RBs and/or RBGs in the second subset of RBs.

As shown by reference number 510, the UE 504 may determine a second starting RB based at least in part on a modulo function of a sum of the first starting RB, RBₛₜₐᵣₜ, and the RB offset, RB_{offset}, where the second starting RB is an RB of the second subset of RBs having a lowest frequency value of a plurality of frequency values corresponding to the second subset of RBs. In some aspects, the modulo function includes a modulus equal to a quantity, N_{RB}^{UL,BWP}, of RBs corresponding to an UL bandwidth part (BWP). For example, the second starting RB may be determined by:

(RBₛₜₐᵣₜ+RB_{offset})mod N_{RB}^{UL,BWP}.

In some aspects, the FDM uplink shared channel configuration may configure a set of potential RB offset values. The DCI transmission may indicate a selected RB offset value of the set of potential RB offset values, where the selected RB offset value corresponds to the RB offset. In some aspects, the set of potential RB offset values may be a frequency hopping RB offset list. In some other aspects, the set of potential offset values may be a different list than a list of frequency hopping RB offsets. In some aspects, the DCI transmission may correspond to a specified DCI format and the set of potential RB offset values may be associated with the specified DCI format. In some aspects, the FDM uplink shared channel configuration may include an additional set of potential RB offset values associated with the specified DCI format.

In some aspects, the set of potential RB offset values may consist of one potential RB offset value, and the one potential RB offset value may correspond to the RB offset. In some aspects, the set of potential RB offset values may consist of a first potential RB offset value and a second potential RB offset value. An MSB, of a plurality of bits of the FDRA field of the DCI transmission may indicate, as the RB offset, the first potential RB offset value or the second potential RB offset value. A set of remaining bits of the FDRA field may indicate the first starting RB and a quantity of RBs in the first subset of RBs. The set of remaining bits may exclude the MSB.

In some aspects, the set of potential RB offset values may consist of four potential RB offset values. A first two MSBs, of a plurality of bits of the FDRA field of the DCI transmission, may indicate a potential RB offset value, of the set of potential RB offset values, as the RB offset. A set of remaining bits of the FDRA field may indicate the first starting RB and a quantity of RBs in the first subset of RBs. The set of remaining bits may exclude the first two MSBs.

As shown by reference number 512, the UE 504 may transmit, and the network node 502 may receive, an uplink shared channel signal based at least in part on the FDM uplink shared channel configuration. In this way, some aspects may facilitate transmitting two frequency-offset subsets of RBs, thereby facilitating efficient and successful uplink communications.

As indicated above, FIG. 5 is provided as an example. Other examples may differ from what is described with respect to FIG. 5.

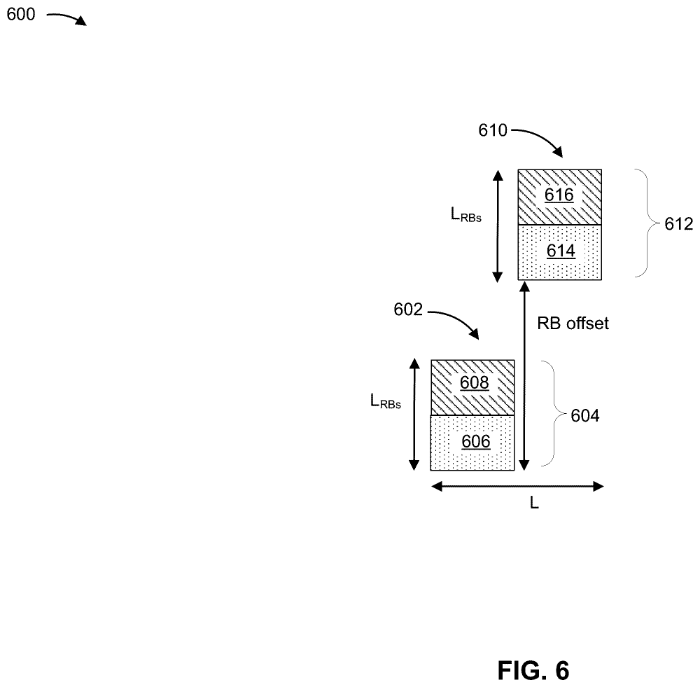

FIG. 6 is a diagram of an example 600 associated with resource allocation for FDM uplink shared channel configurations, in accordance with the present disclosure. Example 600 depicts an RB allocation scheme that may be used by a UE (e.g., the UE 504) to transmit a PUSCH transmission to a network node (e.g., the network node 502).

In some aspects, for example, the UE may receive a frequency hopping indication having a specified value. The UE may transmit the uplink shared channel signal based at least in part on applying an FDM uplink configuration (e.g., as described in connection with FIG. 5) based at least in part on the frequency hopping indication having the specified value.

For example, in some aspects, the UE may not expect to be scheduled with both FDM PUSCH and frequency hopping. The UE may apply an FDM uplink shared channel configuration only if a frequency hopping flag is set to 0 and is indicated with an FDM PUSCH scheme (e.g., by an SRS resource set indicator field of the DCI and/or RRC configuration). When the frequency hopping flag is set to 1, the UE may not expect to be indicated with an FDM PUSCH scheme.

In some aspects, for example, if the UE receives a frequency hopping indication having a specified value indicating that frequency hopping is enabled, the UE may transmit a first group 602 of RBs in a first frequency hop 604. The first group 602 of RBs may include a first portion 606 of a first subset of RBs of a set of RBs and a first portion 608 of a second subset of RBs of the set of RBs. The UE may transmit a second group 610 of RBs in a second frequency hop 612. The second group 610 of RBs may include a second portion 614 of the first subset of RBs and a second portion 616 of the second subset of RBs. For example, in the first frequency hop 604, the first ┌L_{RBs}/2┐ RBs of the set of RBs may belong to the first portion 606 and the remaining └L_{RBs}/2┘ RBs may belong to the first portion 608. This pattern may be repeated in the second frequency hop 612.

In some aspects, the RB offset comprises a frequency hopping RB offset. The frequency hopping RB offset may determine the second frequency hop. In some aspects, the first portion 606 of the first subset of RBs may be based at least in part on a ceiling function of a product of one half and a length of the first subset of RBs, and the first portion 608 of the second subset of RBs may be based at least in part on a floor function of a product of one half and a length of the second subset of RBs. In some aspects, the second portion 614 of the first subset of RBs may be based at least in part on a ceiling function of a product of one half and a length of the first subset of RBs, and the second portion 616 of the second subset of RBs may be based at least in part on a floor function of a product of one half and a length of the second subset of RBs. For example, in the second frequency hop 612, the portions 614 and 616 may be determined by ┌L_{RBs}/2┐ versus └L_{RBs}/2┘ for the two RBs in the first frequency hop 604.

In some aspects, the first portion 606 of the first subset of RBs may be based at least in part on a ceiling function of a product of one half and a length of the first subset of RBs, and the first portion 608 of the second subset of RBs is based at least in part on a floor function of a product of one half and a length of the second subset of RBs. The second portion 614 of the first subset of RBs may be based at least in part on a floor function of a product of one half and a length of the first subset of RBs, and the second portion 616 of the second subset of RBs may be based at least in part on a ceiling function of a product of one half and a length of the second subset of RBs. For example, in the second frequency hop 612, the portions 614 and 616 may be determined by └L_{RBs}/2┘ versus ┌L_{RBs}/2┐ RBs.

In this way, for example, some aspects of the subject matter disclosed herein may provide a mechanism for facilitating FDM PUSCH transmission in connection with frequency hopping, in which the RBs are at least approximately evenly divided between subsets and frequency hops, thereby increasing the opportunity for successful reception by the network.

As indicated above, FIG. 6 is provided as an example. Other examples may differ from what is described with respect to FIG. 6.

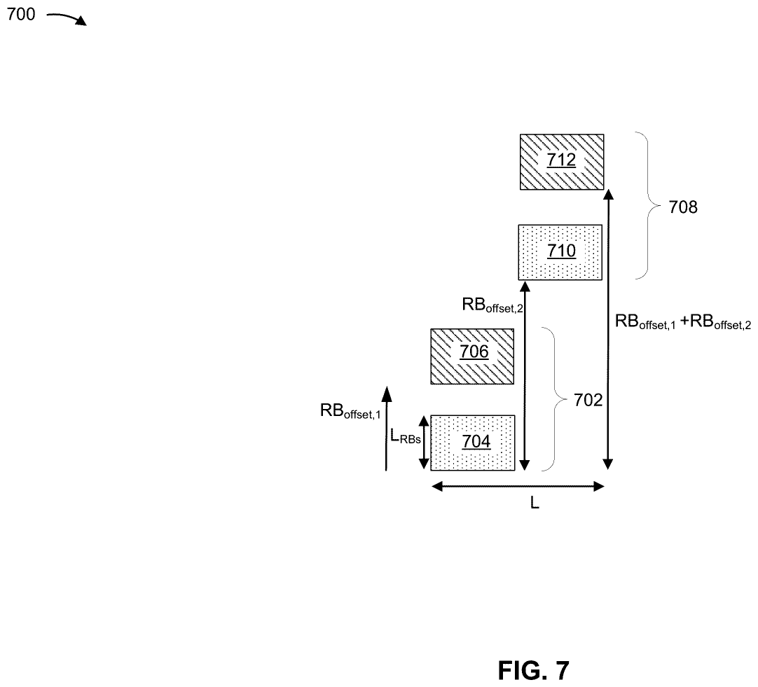

FIG. 7 is a diagram of an example 700 associated with resource allocation for FDM uplink shared channel configurations, in accordance with the present disclosure. Example 700 depicts an RB allocation scheme that may be used by a UE (e.g., the UE 504) to transmit a PUSCH transmission to a network node (e.g., the network node 502).

In some aspects, for example, frequency hopping may be enabled, and the UE may transmit, in a first frequency hop 702, a first portion 704 of the first subset of RBs and a first portion 706 of the second subset of RBs. The UE may transmit, in a second frequency hop 708, a second portion 710 of the first subset of RBs and a second portion 712 of the second subset of RBs. In some aspects, for example, the UE may receive a first set of potential RB offset values associated with the RB offset, RB_{offset,1}, and a second set of potential RB offset values associated with a frequency offset, RB_{offset,2}, between the first frequency hop and the second frequency hop. For example, the first set of potential offset values may include Y RB offset values, and the second set of potential values may include X RB offset values.

In some aspects, the UE may receive a DCI transmission including an FDRA field that indicates a first allocation of the first portion 704 of the first subset of RBs associated with the first frequency hop. A quantity of bits of the FDRA field used to indicate the first allocation may be based at least in part on a ceiling of a log function of a quantity of RBs in an uplink bandwidth part minus a ceiling of a log function of a quantity of potential RB offset values in the first set of potential RB offset values minus a ceiling of a log function of a quantity of potential RB offset values in the second set of potential RB offset values. That is, for example, the allocated RBs in the first frequency hop 702 may be determined by ┌log₂(N_{RB}^{UL,BWP}(N_{RB}^{UL,BWP}+1)/2)┐−┌log₂ X┐−┌log₂ Y┐.

A quantity of RBs in the first portion 704 of the first subset of RBs may equal a quantity of RBs in the first portion 706 of the second subset of RBs. For example, the second set of RBs of the first frequency hop 702 may have the same number of RBs with a starting RB determined by (RBₛₜₐᵣₜ+RB_{offset,1}) mod N_{RB}^{UL,BWP}. In some aspects, the UE may receive a DCI transmission including an FDRA field that indicates a first selected RB offset value of the first set of potential RB offset values. A first quantity of bits of the FDRA field used to indicate the first selected RB offset value may be based at least in part on a ceiling function of a log function of a quantity of potential RB offset values of the first set of potential RB values. A second starting RB associated with the first portion 710 of the second subset of RBs may be based at least in part on a modulo function of a sum of the first starting RB and the first selected RB offset value. For example, the second set of RBs of the first frequency hop 702 may have the same number of RBs with a starting RB as (RBₛₜₐᵣₜ+RB_{offset,1}) mod N_{RB}^{UL,BWP}, and └log₂ Y┐ bits of the FDRA field may be used to indicate the value of RB_{offset,1} from the list of Y RB offset values.

In some aspects, a third starting RB associated with the second portion 710 of the first subset of RBs may be based at least in part on a modulo function of a sum of the first starting RB and a second selected RB offset value of the second set of potential RB values. A second quantity of bits of the FDRA field used to indicate the second selected RB offset value may be based at least in part on a ceiling function of a log function of a quantity of potential RB offset values in the second set of potential RB offset values. For example, the first set of RBs of the second frequency hop may have the same number of RBs with a starting RB as (RBₛₜₐᵣₜ+RB_{offset,2}) mod N_{RB}^{UL,BWP}, and ┌log₂ X┐ bits of the FDRA field may be used to indicate the value of RB_{offset,2} from the list of X RB offset values.

In some aspects, a fourth starting RB associated with the second portion 712 of the second subset of RBs may be based at least in part on a modulo function of a sum of the first starting RB, the first selected RB offset value, and the second selected RB offset value. For example, the second set of RBs of the second frequency hop have the same number of RBs with a starting RB as (RBₛₜₐᵣₜ+RB_{offset,1}+RB_{offset,2}) mod N_{RB}^{UL,BWP}.

In this way, for example, some aspects of the subject matter disclosed herein may provide a mechanism for facilitating FDM PUSCH transmission in connection with frequency hopping, in which the RBs are at least approximately evenly divided between subsets and frequency hops, thereby increasing the opportunity for successful reception by the network.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 504) performs operations associated with resource allocation for FDM uplink shared channel configurations.

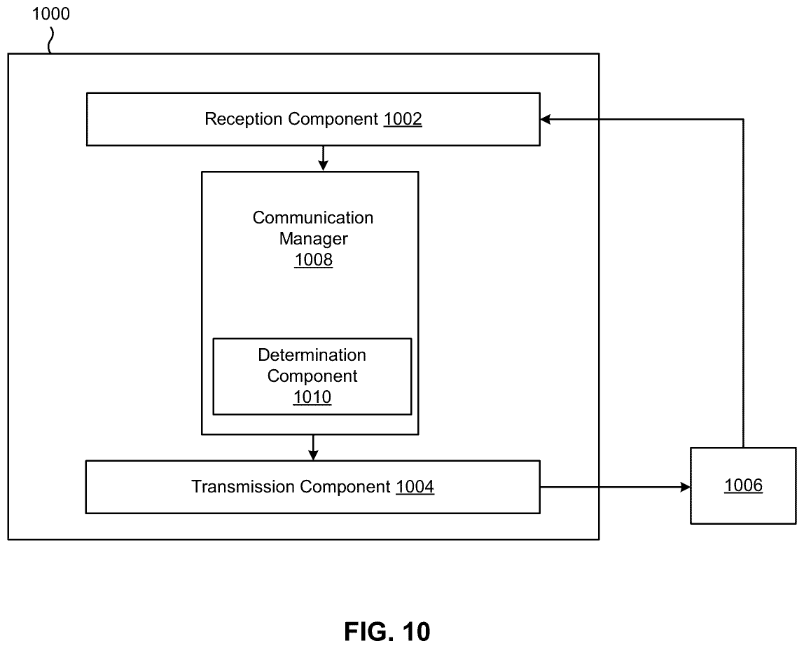

As shown in FIG. 8, in some aspects, process 800 may include receiving an FDM uplink shared channel configuration associated with an RB partitioning scheme for partitioning a set of allocated RBs into a first subset of RBs and a second subset of RBs, wherein the second subset of RBs is associated with an RB offset corresponding to a first starting RB, the first starting RB comprising an RB of the first subset of RBs having a lowest frequency value of a plurality of frequency values corresponding to the first subset of RBs (block 810). For example, the UE (e.g., using communication manager 1008 and/or reception component 1002, depicted in FIG. 10) may receive an FDM uplink shared channel configuration associated with an RB partitioning scheme for partitioning a set of allocated RBs into a first subset of RBs and a second subset of RBs, wherein the second subset of RBs is associated with an RB offset corresponding to a first starting RB, the first starting RB comprising an RB of the first subset of RBs having a lowest frequency value of a plurality of frequency values corresponding to the first subset of RBs, as described above.

As further shown in FIG. 8, in some aspects, process 800 may include transmitting an uplink shared channel signal based at least in part on the FDM uplink shared channel configuration (block 820). For example, the UE (e.g., using communication manager 1008 and/or transmission component 1004, depicted in FIG. 10) may transmit an uplink shared channel signal based at least in part on the FDM uplink shared channel configuration, as described above.

Process 800 may include additional aspects, such as any single aspect or any combination of aspects described below and/or in connection with one or more other processes described elsewhere herein.

In a first aspect, process 800 includes receiving a DCI transmission comprising an FDRA field that indicates the set of RBs. In a second aspect, alone or in combination with the first aspect, the FDRA field indicates the first starting RB and a first quantity of RBs included in the first subset of RBs. In a third aspect, alone or in combination with the second aspect, the second subset of RBs includes a second quantity of RBs, and the second quantity of RBs matches the first quantity of RBs.

In a fourth aspect, alone or in combination with one or more of the first through third aspects, process 800 includes determining a second starting RB (block 830) based at least in part on a modulo function of a sum of the first starting RB and the RB offset, and the second starting RB comprises an RB of the second subset of RBs having a lowest frequency value of a plurality of frequency values corresponding to the second subset of RBs. In a fifth aspect, alone or in combination with the fourth aspect, the modulo function includes a modulus equal to a quantity of RBs corresponding to an uplink bandwidth part.

In a sixth aspect, alone or in combination with one or more of the first through fifth aspects, the FDM uplink shared channel configuration configures a set of potential RB offset values, and process 800 includes receiving a DCI transmission that indicates a selected RB offset value of the set of potential RB offset values, wherein the selected RB offset value corresponds to the RB offset. In a seventh aspect, alone or in combination with the sixth aspect, the set of potential RB offset values is a frequency hopping RB offset list. In an eighth aspect, alone or in combination with one or more of the sixth through seventh aspects, the DCI transmission corresponds to a specified DCI format, and the set of potential RB offset values is associated with the specified DCI format. In a ninth aspect, alone or in combination with the eighth aspect, the FDM uplink shared channel configuration comprises an additional set of potential RB offset values associated with the specified DCI format.

In a tenth aspect, alone or in combination with the sixth aspect, the set of potential RB offset values consists of one potential RB offset value, and the one potential RB offset value corresponds to the RB offset. In an eleventh aspect, alone or in combination with the seventh aspect, the set of potential RB offset values consists of a first potential RB offset value and a second potential RB offset value, and a most significant bit, of a plurality of bits of an FDRA field of the DCI transmission, indicates, as the RB offset, the first potential RB offset value or the second potential RB offset value. In a twelfth aspect, alone or in combination with the eleventh aspect, a set of remaining bits of the FDRA field indicates the first starting RB and a quantity of RBs in the first subset of RBs, the set of remaining bits excluding the most significant bit.

In a thirteenth aspect, alone or in combination with the sixth aspect, the set of potential RB offset values consists of four potential RB offset values, and a first two most significant bits, of a plurality of bits of an FDRA field of the DCI transmission, indicate a potential RB offset value, of the set of potential RB offset values, as the RB offset. In a fourteenth aspect, alone or in combination with the thirteenth aspect, a set of remaining bits of the FDRA field indicates the first starting RB and a quantity of RBs in the first subset of RBs, the set of remaining bits excluding the first two most significant bits.

In a fifteenth aspect, alone or in combination with one or more of the first through fourteenth aspects, process 800 includes receiving a frequency hopping indication having a specified value, wherein transmitting the uplink shared channel signal based at least in part on the FDM uplink shared channel configuration comprises applying the FDM uplink configuration based at least in part on the frequency hopping indication having the specified value. In a sixteenth aspect, alone or in combination with one or more of the first through fifteenth aspects, process 800 includes receiving a frequency hopping indication having a specified value indicating that frequency hopping is enabled, wherein transmitting the uplink shared channel signal comprises transmitting, based at least in part on the frequency hopping indication having the specified value a first group of RBs in a first frequency hop, the first group of RBs comprising a first portion of the first subset of RBs and a first portion of the second subset of RBs, and a second group of RBs in a second frequency hop, the second group of RBs comprising a second portion of the first subset of RBs and a second portion of the second subset of RBs.

In a seventeenth aspect, alone or in combination with the sixteenth aspect, the RB offset comprises a frequency hopping RB offset. In an eighteenth aspect, alone or in combination with one or more of the sixteenth through seventeenth aspects, the first portion of the first subset of RBs is based at least in part on a ceiling function of a product of one half and a length of the first subset of RBs, and the first portion of the second subset of RBs is based at least in part on a floor function of a product of one half and a length of the second subset of RBs. In a nineteenth aspect, alone or in combination with one or more of the sixteenth through eighteenth aspects, the second portion of the first subset of RBs is based at least in part on a ceiling function of a product of one half and a length of the first subset of RBs, and the second portion of the second subset of RBs is based at least in part on a floor function of a product of one half and a length of the second subset of RBs.

In a twentieth aspect, alone or in combination with one or more of the sixteenth through nineteenth aspects, the first portion of the first subset of RBs is based at least in part on a ceiling function of a product of one half and a length of the first subset of RBs, and the first portion of the second subset of RBs is based at least in part on a floor function of a product of one half and a length of the second subset of RBs. In a twenty-first aspect, alone or in combination with one or more of the sixteenth through twentieth aspects, the second portion of the first subset of RBs is based at least in part on a floor function of a product of one half and a length of the first subset of RBs, and the second portion of the second subset of RBs is based at least in part on a ceiling function of a product of one half and a length of the second subset of RBs.

In a twenty-second aspect, alone or in combination with one or more of the first through twenty-first aspects, frequency hopping is enabled, and transmitting the uplink shared channel signal comprises transmitting, in a first frequency hop, a first portion of the first subset of RBs and a first portion of the second subset of RBs, and transmitting, in a second frequency hop, a second portion of the first subset of RBs and a second portion of the second subset of RBs.

In a twenty-third aspect, alone or in combination with one or more of the first through twenty-second aspects, process 800 includes receiving a first set of potential RB offset values associated with the RB offset, and receiving a second set of potential RB offset values associated with a frequency offset between the first frequency hop and the second frequency hop. In a twenty-fourth aspect, alone or in combination with one or more of the first through twenty-third aspects, process 800 includes receiving a DCI transmission including an FDRA field that indicates a first allocation of the first portion of the first subset of RBs associated with the first frequency hop, wherein a quantity of bits of the FDRA field used to indicate the first allocation is based at least in part on a ceiling of a log function of a quantity of RBs in an uplink bandwidth part minus a ceiling of a log function of a quantity of potential RB offset values in the first set of potential RB offset values minus a ceiling of a log function of a quantity of potential RB offset values in the second set of potential RB offset values.

In a twenty-fifth aspect, alone or in combination with one or more of the first through twenty-fourth aspects, a quantity of RBs in the first portion of the first subset of RBs equals a quantity of RBs in the first portion of the second subset of RBs. In a twenty-sixth aspect, alone or in combination with one or more of the first through twenty-fifth aspects, process 800 includes receiving a DCI transmission including an FDRA field that indicates a first selected RB offset value of the first set of potential RB offset values, and a first quantity of bits of the FDRA field used to indicate the first selected RB offset value is based at least in part on a ceiling function of a log function of a quantity of potential RB offset values of the first set of potential RB values.

In a twenty-seventh aspect, alone or in combination with one or more of the first through twenty-sixth aspects, a second starting RB associated with the first portion of the second subset of RBs is based at least in part on a modulo function of a sum of the first starting RB and the first selected RB offset value. In a twenty-eighth aspect, alone or in combination with one or more of the first through twenty-seventh aspects, a third starting RB associated with the second portion of the first subset of RBs is based at least in part on a modulo function of a sum of the first starting RB and a second selected RB offset value of the second set of potential RB values.

In a twenty-ninth aspect, alone or in combination with one or more of the first through twenty-eighth aspects, a second quantity of bits of the FDRA field used to indicate the second selected RB offset value is based at least in part on a ceiling function of a log function of a quantity of potential RB offset values in the second set of potential RB offset values. In a thirtieth aspect, alone or in combination with one or more of the first through twenty-ninth aspects, a fourth starting RB associated with the second portion of the second subset of RBs is based at least in part on a modulo function of a sum of the first starting RB, the first selected RB offset value, and the second selected RB offset value.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 502) performs operations associated with resource allocation for FDM uplink shared channel configurations.

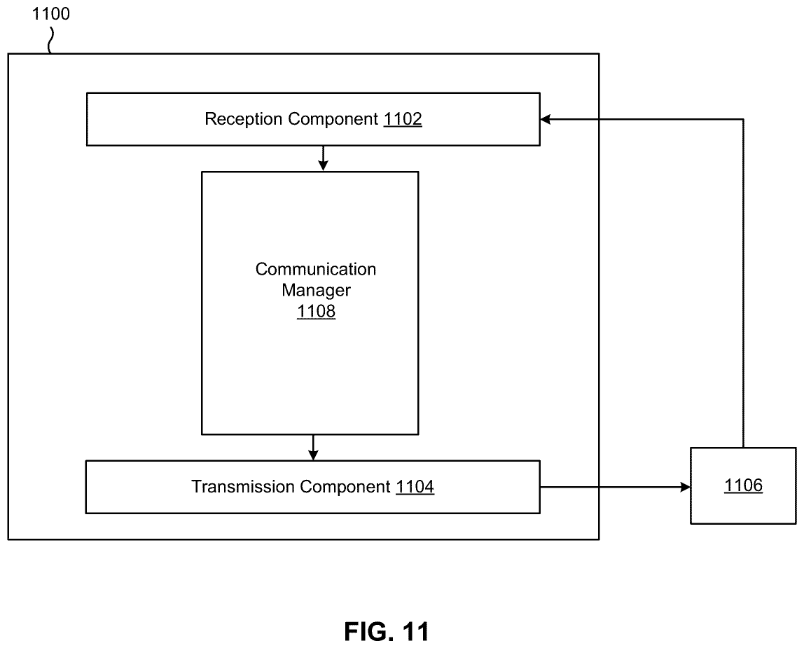

As shown in FIG. 9, in some aspects, process 900 may include transmitting an FDM uplink shared channel configuration associated with an RB partitioning scheme for partitioning a set of allocated RBs into a first subset of RBs and a second subset of RBs, wherein the second subset of RBs is associated with an RB offset corresponding to a first starting RB, the first starting RB comprising an RB of the first subset of RBs having a lowest frequency value of a plurality of frequency values corresponding to the first subset of RBs (block 910). For example, the network node (e.g., using communication manager 1108 and/or transmission component 1104, depicted in FIG. 11) may transmit an FDM uplink shared channel configuration associated with an RB partitioning scheme for partitioning a set of allocated RBs into a first subset of RBs and a second subset of RBs, wherein the second subset of RBs is associated with an RB offset corresponding to a first starting RB, the first starting RB comprising an RB of the first subset of RBs having a lowest frequency value of a plurality of frequency values corresponding to the first subset of RBs, as described above.

As further shown in FIG. 9, in some aspects, process 900 may include receiving an uplink shared channel signal based at least in part on the FDM uplink shared channel configuration (block 920). For example, the network node (e.g., using communication manager 1108 and/or reception component 1102, depicted in FIG. 11) may receive an uplink shared channel signal based at least in part on the FDM uplink shared channel configuration, as described above.

Process 900 may include additional aspects, such as any single aspect or any combination of aspects described below and/or in connection with one or more other processes described elsewhere herein.

In a first aspect, process 900 includes transmitting a DCI transmission comprising an FDRA field that indicates the set of RBs. In a second aspect, alone or in combination with the first aspect, the FDRA field indicates the first starting RB and a first quantity of RBs included in the first subset of RBs. In a third aspect, alone or in combination with one or more of the first and second aspects, the second subset of RBs includes a second quantity of RBs, and the second quantity of RBs matches the first quantity of RBs.

In a fourth aspect, alone or in combination with one or more of the second or third aspects, a second starting RB is based at least in part on a modulo function of a sum of the first starting RB and the RB offset, and the second starting RB comprises an RB of the second subset of RBs having a lowest frequency value of a plurality of frequency values corresponding to the second subset of RBs. In a fifth aspect, alone or in combination with the fourth aspect, the modulo function includes a modulus equal to a quantity of RBs corresponding to an uplink bandwidth part.

In a sixth aspect, alone or in combination with one or more of the first through fifth aspects, the FDM uplink shared channel configuration configures a set of potential RB offset values, and process 900 includes transmitting a DCI transmission that indicates a selected RB offset value of the set of potential RB offset values, wherein the selected RB offset value corresponds to the RB offset. In a seventh aspect, alone or in combination with the sixth aspect, the set of potential RB offset values is a frequency hopping RB offset list. In an eighth aspect, alone or in combination with one or more of the sixth or seventh aspects, the DCI transmission corresponds to a specified DCI format, and the set of potential RB offset values is associated with the specified DCI format. In a ninth aspect, alone or in combination with the eighth aspect, the FDM uplink shared channel configuration comprises an additional set of potential RB offset values associated with the specified DCI format.

In a tenth aspect, alone or in combination with one or more of the sixth through ninth aspects, the set of potential RB offset values consists of one potential RB offset value, and the one potential RB offset value corresponds to the RB offset. In an eleventh aspect, alone or in combination with one or more of the sixth through tenth aspects, the set of potential RB offset values consists of a first potential RB offset value and a second potential RB offset value, and a most significant bit, of a plurality of bits of an FDRA field of the DCI transmission, indicates, as the RB offset, the first potential RB offset value or the second potential RB offset value. In a twelfth aspect, alone or in combination with the eleventh aspect, a set of remaining bits of the FDRA field indicates the first starting RB and a quantity of RBs in the first subset of RBs, the set of remaining bits excluding the most significant bit.

In a thirteenth aspect, alone or in combination with one or more of the sixth through twelfth aspects, the set of potential RB offset values consists of four potential RB offset values, and a first two most significant bits, of a plurality of bits of an FDRA field of the DCI transmission, indicate a potential RB offset value, of the set of potential RB offset values, as the RB offset. In a fourteenth aspect, alone or in combination with the thirteenth aspect, a set of remaining bits of the FDRA field indicates the first starting RB and a quantity of RBs in the first subset of RBs, the set of remaining bits excluding the first two most significant bits.

In a fifteenth aspect, alone or in combination with one or more of the first through fourteenth aspects, process 900 includes transmitting a frequency hopping indication having a specified value, wherein receiving the uplink shared channel signal based at least in part on the FDM uplink shared channel configuration comprises receiving the uplink shared channel signal in accordance with the FDM uplink configuration based at least in part on the frequency hopping indication having the specified value.

In a sixteenth aspect, alone or in combination with one or more of the first through fifteenth aspects, process 900 includes transmitting a frequency hopping indication having a specified value indicating that frequency hopping is enabled, wherein receiving the uplink shared channel signal comprises receiving, based at least in part on the frequency hopping indication having the specified value a first group of RBs in a first frequency hop, the first group of RBs comprising a first portion of the first subset of RBs and a first portion of the second subset of RBs, and a second group of RBs in a second frequency hop, the second group of RBs comprising a second portion of the first subset of RBs and a second portion of the second subset of RBs. In a seventeenth aspect, alone or in combination with the sixteenth aspect, the RB offset comprises a frequency hopping RB offset. In an eighteenth aspect, alone or in combination with one or more of the sixteenth or seventeenth aspects, the first portion of the first subset of RBs is based at least in part on a ceiling function of a product of one half and a length of the first subset of RBs, and the first portion of the second subset of RBs is based at least in part on a floor function of a product of one half and a length of the second subset of RBs. In a nineteenth aspect, alone or in combination with one or more of the sixteenth through eighteenth aspects, the second portion of the first subset of RBs is based at least in part on a ceiling function of a product of one half and a length of the first subset of RBs, and the second portion of the second subset of RBs is based at least in part on a floor function of a product of one half and a length of the second subset of RBs.

In a twentieth aspect, alone or in combination with one or more of the sixteenth through nineteenth aspects, the first portion of the first subset of RBs is based at least in part on a ceiling function of a product of one half and a length of the first subset of RBs, and the first portion of the second subset of RBs is based at least in part on a floor function of a product of one half and a length of the second subset of RBs. In a twenty-first aspect, alone or in combination with one or more of the sixteenth through twentieth aspects, the second portion of the first subset of RBs is based at least in part on a floor function of a product of one half and a length of the first subset of RBs, and the second portion of the second subset of RBs is based at least in part on a ceiling function of a product of one half and a length of the second subset of RBs.

In a twenty-second aspect, alone or in combination with one or more of the first through twenty-first aspects, frequency hopping is enabled, and receiving the uplink shared channel signal comprises receiving, in a first frequency hop, a first portion of the first subset of RBs and a first portion of the second subset of RBs, and receiving, in a second frequency hop, a second portion of the first subset of RBs and a second portion of the second subset of RBs. In a twenty-third aspect, alone or in combination with the twenty-second aspect, process 900 includes transmitting a first set of potential RB offset values associated with the RB offset, and transmitting a second set of potential RB offset values associated with a frequency offset between the first frequency hop and the second frequency hop. In a twenty-fourth aspect, alone or in combination with the twenty-third aspect, process 900 includes transmitting a DCI transmission including an FDRA field that indicates a first allocation of the first portion of the first subset of RBs associated with the first frequency hop, wherein a quantity of bits of the FDRA field used to indicate the first allocation is based at least in part on a ceiling of a log function of a quantity of RBs in an uplink bandwidth part minus a ceiling of a log function of a quantity of potential RB offset values in the first set of potential RB offset values minus a ceiling of a log function of a quantity of potential RB offset values in the second set of potential RB offset values. In a twenty-fifth aspect, alone or in combination with one or more of the twenty-third through twenty-fourth aspects, a quantity of RBs in the first portion of the first subset of RBs equals a quantity of RBs in the first portion of the second subset of RBs.

In a twenty-sixth aspect, alone or in combination with one or more of the twenty-third through twenty-fifth aspects, process 900 includes transmitting a DCI transmission including an FDRA field that indicates a first selected RB offset value of the first set of potential RB offset values, and a first quantity of bits of the FDRA field used to indicate the first selected RB offset value is based at least in part on a ceiling function of a log function of a quantity of potential RB offset values of the first set of potential RB values. In a twenty-seventh aspect, alone or in combination with the twenty-sixth aspect, a second starting RB associated with the first portion of the second subset of RBs is based at least in part on a modulo function of a sum of the first starting RB and the first selected RB offset value.

In a twenty-eighth aspect, alone or in combination with one or more of the twenty-sixth or twenty-seventh aspects, a third starting RB associated with the second portion of the first subset of RBs is based at least in part on a modulo function of a sum of the first starting RB and a second selected RB offset value of the second set of potential RB values. In a twenty-ninth aspect, alone or in combination with the twenty-eighth aspect, a second quantity of bits of the FDRA field used to indicate the second selected RB offset value is based at least in part on a ceiling function of a log function of a quantity of potential RB offset values in the second set of potential RB offset values. In a thirtieth aspect, alone or in combination with the twenty-ninth aspect, a fourth starting RB associated with the second portion of the second subset of RBs is based at least in part on a modulo function of a sum of the first starting RB, the first selected RB offset value, and the second selected RB offset value.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include a communication manager 1008. The communication manager 1008 may include a determination component 1010.

In some aspects, the apparatus 1000 may be configured to perform one or more operations described herein in connection with FIGS. 5-7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive an FDM uplink shared channel configuration associated with an RB partitioning scheme for partitioning a set of allocated RBs into a first subset of RBs and a second subset of RBs, wherein the second subset of RBs is associated with an RB offset corresponding to a first starting RB, the first starting RB comprising an RB of the first subset of RBs having a lowest frequency value of a plurality of frequency values corresponding to the first subset of RBs. The transmission component 1004 may transmit an uplink shared channel signal based at least in part on the FDM uplink shared channel configuration.

The reception component 1002 may receive a DCI transmission comprising an FDRA field that indicates the set of RBs.

The communication manager 1008 and/or the determination component 1010 may determine a second starting RB based at least in part on a modulo function of a sum of the first starting RB and the RB offset, wherein the second starting RB comprises an RB of the second subset of RBs having a lowest frequency value of a plurality of frequency values corresponding to the second subset of RBs. In some aspects, the communication manager 1008 may include one or more antennas, a modem, a controller/processor, a memory, or a combination thereof, of the UE described in connection with FIG. 2. In some aspects, the communication manager 1008 may include the reception component and/or the transmission component. In some aspects, the communication manager 1008 may be, be similar to, include, or be included in, the communication manager 140 depicted in FIGS. 1 and 2. In some aspects, the determination component 1010 may include one or more antennas, a modem, a controller/processor, a memory, or a combination thereof, of the UE described in connection with FIG. 2. In some aspects, the determination component 1010 may include the reception component and/or the transmission component.

The reception component 1002 may receive a frequency hopping indication having a specified value, wherein transmitting the uplink shared channel signal based at least in part on the FDM uplink shared channel configuration comprises applying the FDM uplink configuration based at least in part on the frequency hopping indication having the specified value. The reception component 1002 may receive a frequency hopping indication having a specified value indicating that frequency hopping is enabled, wherein transmitting the uplink shared channel signal comprises transmitting, based at least in part on the frequency hopping indication having the specified value a first group of RBs in a first frequency hop, the first group of RBs comprising a first portion of the first subset of RBs and a first portion of the second subset of RBs; and a second group of RBs in a second frequency hop, the second group of RBs comprising a second portion of the first subset of RBs and a second portion of the second subset of RBs.

The reception component 1002 may receive a first set of potential RB offset values associated with the RB offset. The reception component 1002 may receive a second set of potential RB offset values associated with a frequency offset between the first frequency hop and the second frequency hop. The reception component 1002 may receive a DCI transmission including an FDRA field that indicates a first allocation of the first portion of the first subset of RBs associated with the first frequency hop, wherein a quantity of bits of the FDRA field used to indicate the first allocation is based at least in part on a ceiling of a log function of a quantity of RBs in an uplink bandwidth part minus a ceiling of a log function of a quantity of potential RB offset values in the first set of potential RB offset values minus a ceiling of a log function of a quantity of potential RB offset values in the second set of potential RB offset values. The reception component 1002 may receive a DCI transmission including an FDRA field that indicates a first selected RB offset value of the first set of potential RB offset values, wherein a first quantity of bits of the FDRA field used to indicate the first selected RB offset value is based at least in part on a ceiling function of a log function of a quantity of potential RB offset values of the first set of potential RB values.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include a communication manager 1108.

In some aspects, the apparatus 1100 may be configured to perform one or more operations described herein in connection with FIGS. 5-7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

In some aspects, the communication manager 1108 may include one or more antennas, a modem, a controller/processor, a memory, or a combination thereof, of the network node described in connection with FIG. 2. In some aspects, the communication manager 1108 may include the reception component and/or the transmission component. In some aspects, the communication manager 1108 may be, be similar to, include, or be included in, the communication manager 150 depicted in FIGS. 1 and 2. The communication manager 1108 may perform any of the functions described below in connection with the reception component 1102 and/or the transmission component 1104. The transmission component 1104 may transmit an FDM uplink shared channel configuration associated with an RB partitioning scheme for partitioning a set of allocated RBs into a first subset of RBs and a second subset of RBs, wherein the second subset of RBs is associated with an RB offset corresponding to a first starting RB, the first starting RB comprising an RB of the first subset of RBs having a lowest frequency value of a plurality of frequency values corresponding to the first subset of RBs. The reception component 1102 may receive an uplink shared channel signal based at least in part on the FDM uplink shared channel configuration.

The transmission component 1104 may transmit a DCI transmission comprising an FDRA field that indicates the set of RBs. The transmission component 1104 may transmit a frequency hopping indication having a specified value, wherein receiving the uplink shared channel signal based at least in part on the FDM uplink shared channel configuration comprises receiving the uplink shared channel signal in accordance with the FDM uplink configuration based at least in part on the frequency hopping indication having the specified value.

The transmission component 1104 may transmit a frequency hopping indication having a specified value indicating that frequency hopping is enabled, wherein receiving the uplink shared channel signal comprises receiving, based at least in part on the frequency hopping indication having the specified value a first group of RBs in a first frequency hop, the first group of RBs comprising a first portion of the first subset of RBs and a first portion of the second subset of RBs; and a second group of RBs in a second frequency hop, the second group of RBs comprising a second portion of the first subset of RBs and a second portion of the second subset of RBs. The transmission component 1104 may transmit a first set of potential RB offset values associated with the RB offset. The transmission component 1104 may transmit a second set of potential RB offset values associated with a frequency offset between the first frequency hop and the second frequency hop.

The transmission component 1104 may transmit a DCI transmission including an FDRA field that indicates a first allocation of the first portion of the first subset of RBs associated with the first frequency hop, wherein a quantity of bits of the FDRA field used to indicate the first allocation is based at least in part on a ceiling of a log function of a quantity of RBs in an uplink bandwidth part minus a ceiling of a log function of a quantity of potential RB offset values in the first set of potential RB offset values minus a ceiling of a log function of a quantity of potential RB offset values in the second set of potential RB offset values. The transmission component 1104 may transmit a DCI transmission including an FDRA field that indicates a first selected RB offset value of the first set of potential RB offset values, wherein a first quantity of bits of the FDRA field used to indicate the first selected RB offset value is based at least in part on a ceiling function of a log function of a quantity of potential RB offset values of the first set of potential RB values.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving a frequency division multiplexing (FDM) uplink shared channel configuration associated with a resource block (RB) partitioning scheme for partitioning a set of allocated RBs into a first subset of RBs and a second subset of RBs, wherein the second subset of RBs is associated with an RB offset corresponding to a first starting RB, the first starting RB comprising an RB of the first subset of RBs having a lowest frequency value of a plurality of frequency values corresponding to the first subset of RBs; and transmitting an uplink shared channel signal based at least in part on the FDM uplink shared channel configuration.

Aspect 2: The method of Aspect 1, further comprising receiving a downlink control information (DCI) transmission comprising a frequency domain resource allocation (FDRA) field that indicates the set of RBs.

Aspect 3: The method of Aspect 2, wherein the FDRA field indicates the first starting RB and a first quantity of RBs included in the first subset of RBs.

Aspect 4: The method of Aspect 3, wherein the second subset of RBs includes a second quantity of RBs, and wherein the second quantity of RBs matches the first quantity of RBs.

Aspect 5: The method of any of Aspects 1-4, further comprising determining a second starting RB based at least in part on a modulo function of a sum of the first starting RB and the RB offset, and wherein the second starting RB comprises an RB of the second subset of RBs having a lowest frequency value of a plurality of frequency values corresponding to the second subset of RBs.

Aspect 6: The method of Aspect 5, wherein the modulo function includes a modulus equal to a quantity of RBs corresponding to an uplink bandwidth part.

Aspect 7: The method of any of Aspects 1-6, wherein the FDM uplink shared channel configuration configures a set of potential RB offset values, the method further comprising receiving a downlink control information (DCI) transmission that indicates a selected RB offset value of the set of potential RB offset values, wherein the selected RB offset value corresponds to the RB offset.

Aspect 8: The method of Aspect 7, wherein the set of potential RB offset values is a frequency hopping RB offset list.

Aspect 9: The method of either of Aspects 7 or 8, wherein the DCI transmission corresponds to a specified DCI format, and wherein the set of potential RB offset values is associated with the specified DCI format.

Aspect 10: The method of Aspect 9, wherein the FDM uplink shared channel configuration comprises an additional set of potential RB offset values associated with the specified DCI format.

Aspect 11: The method of Aspect 7, wherein the set of potential RB offset values consists of one potential RB offset value, and wherein the one potential RB offset value corresponds to the RB offset.

Aspect 12: The method of Aspect 7, wherein the set of potential RB offset values consists of a first potential RB offset value and a second potential RB offset value, and wherein a most significant bit, of a plurality of bits of a frequency domain resource allocation (FDRA) field of the DCI transmission, indicates, as the RB offset, the first potential RB offset value or the second potential RB offset value.

Aspect 13: The method of Aspect 12, wherein a set of remaining bits of the FDRA field indicates the first starting RB and a quantity of RBs in the first subset of RBs, the set of remaining bits excluding the most significant bit.

Aspect 14: The method of Aspect 7, wherein the set of potential RB offset values consists of four potential RB offset values, and wherein a first two most significant bits, of a plurality of bits of a frequency domain resource allocation (FDRA) field of the DCI transmission, indicate a potential RB offset value, of the set of potential RB offset values, as the RB offset.

Aspect 15: The method of Aspect 14, wherein a set of remaining bits of the FDRA field indicates the first starting RB and a quantity of RBs in the first subset of RBs, the set of remaining bits excluding the first two most significant bits.

Aspect 16: The method of any of Aspects 1-15, further comprising receiving a frequency hopping indication having a specified value, wherein transmitting the uplink shared channel signal based at least in part on the FDM uplink shared channel configuration comprises applying the FDM uplink configuration based at least in part on the frequency hopping indication having the specified value.

Aspect 17: The method of any of Aspects 1-16, further comprising receiving a frequency hopping indication having a specified value indicating that frequency hopping is enabled, wherein transmitting the uplink shared channel signal comprises transmitting, based at least in part on the frequency hopping indication having the specified value: a first group of RBs in a first frequency hop, the first group of RBs comprising a first portion of the first subset of RBs and a first portion of the second subset of RBs; and a second group of RBs in a second frequency hop, the second group of RBs comprising a second portion of the first subset of RBs and a second portion of the second subset of RBs.

Aspect 18: The method of Aspect 17, wherein the RB offset comprises a frequency hopping RB offset.

Aspect 19: The method of either of Aspects 17 or 18, wherein the first portion of the first subset of RBs is based at least in part on a ceiling function of a product of one half and a length of the first subset of RBs, and wherein the first portion of the second subset of RBs is based at least in part on a floor function of a product of one half and a length of the second subset of RBs.

Aspect 20: The method of any of Aspects 17-19, wherein the second portion of the first subset of RBs is based at least in part on a ceiling function of a product of one half and a length of the first subset of RBs, and wherein the second portion of the second subset of RBs is based at least in part on a floor function of a product of one half and a length of the second subset of RBs.

Aspect 21: The method of any of Aspects 17-20, wherein the first portion of the first subset of RBs is based at least in part on a ceiling function of a product of one half and a length of the first subset of RBs, and wherein the first portion of the second subset of RBs is based at least in part on a floor function of a product of one half and a length of the second subset of RBs.

Aspect 22: The method of any of Aspects 17-21, wherein the second portion of the first subset of RBs is based at least in part on a floor function of a product of one half and a length of the first subset of RBs, and wherein the second portion of the second subset of RBs is based at least in part on a ceiling function of a product of one half and a length of the second subset of RBs.

Aspect 23: The method of any of Aspects 1-22, wherein frequency hopping is enabled, and wherein transmitting the uplink shared channel signal comprises transmitting, in a first frequency hop, a first portion of the first subset of RBs and a first portion of the second subset of RBs; and transmitting, in a second frequency hop, a second portion of the first subset of RBs and a second portion of the second subset of RBs.

Aspect 24: The method of Aspect 23, further comprising: receiving a first set of potential RB offset values associated with the RB offset; and receiving a second set of potential RB offset values associated with a frequency offset between the first frequency hop and the second frequency hop.

Aspect 25: The method of Aspect 24, further comprising receiving a downlink control information (DCI) transmission including a frequency domain resource allocation (FDRA) field that indicates a first allocation of the first portion of the first subset of RBs associated with the first frequency hop, wherein a quantity of bits of the FDRA field used to indicate the first allocation is based at least in part on a ceiling of a log function of a quantity of RBs in an uplink bandwidth part minus a ceiling of a log function of a quantity of potential RB offset values in the first set of potential RB offset values minus a ceiling of a log function of a quantity of potential RB offset values in the second set of potential RB offset values.

Aspect 26: The method of either of Aspects 24 or 25, wherein a quantity of RBs in the first portion of the first subset of RBs equals a quantity of RBs in the first portion of the second subset of RBs.

Aspect 27: The method of any of Aspects 24-26, further comprising receiving a downlink control information (DCI) transmission including a frequency domain resource allocation (FDRA) field that indicates a first selected RB offset value of the first set of potential RB offset values, and wherein a first quantity of bits of the FDRA field used to indicate the first selected RB offset value is based at least in part on a ceiling function of a log function of a quantity of potential RB offset values of the first set of potential RB values.

Aspect 28: The method of Aspect 27, wherein a second starting RB associated with the first portion of the second subset of RBs is based at least in part on a modulo function of a sum of the first starting RB and the first selected RB offset value.

Aspect 29: The method of either of Aspects 27 or 28, wherein a third starting RB associated with the second portion of the first subset of RBs is based at least in part on a modulo function of a sum of the first starting RB and a second selected RB offset value of the second set of potential RB values.

Aspect 30: The method of Aspect 29, wherein a second quantity of bits of the FDRA field used to indicate the second selected RB offset value is based at least in part on a ceiling function of a log function of a quantity of potential RB offset values in the second set of potential RB offset values.

Aspect 31: The method of Aspect 30, wherein a fourth starting RB associated with the second portion of the second subset of RBs is based at least in part on a modulo function of a sum of the first starting RB, the first selected RB offset value, and the second selected RB offset value.

Aspect 32: A method of wireless communication performed by a network node, comprising: transmitting a frequency division multiplexing (FDM) uplink shared channel configuration associated with a resource block (RB) partitioning scheme for partitioning a set of allocated RBs into a first subset of RBs and a second subset of RBs, wherein the second subset of RBs is associated with an RB offset corresponding to a first starting RB, the first starting RB comprising an RB of the first subset of RBs having a lowest frequency value of a plurality of frequency values corresponding to the first subset of RBs; and receiving an uplink shared channel signal based at least in part on the FDM uplink shared channel configuration.

Aspect 33: The method of Aspect 32, further comprising transmitting a downlink control information (DCI) transmission comprising a frequency domain resource allocation (FDRA) field that indicates the set of RBs.

Aspect 34: The method of Aspect 33, wherein the FDRA field indicates the first starting RB and a first quantity of RBs included in the first subset of RBs.

Aspect 35: The method of Aspect 34, wherein the second subset of RBs includes a second quantity of RBs, and wherein the second quantity of RBs matches the first quantity of RBs.

Aspect 36: The method of any of Aspects 32-35, wherein a second starting RB is based at least in part on a modulo function of a sum of the first starting RB and the RB offset, and wherein the second starting RB comprises an RB of the second subset of RBs having a lowest frequency value of a plurality of frequency values corresponding to the second subset of RBs.

Aspect 37: The method of Aspect 36, wherein the modulo function includes a modulus equal to a quantity of RBs corresponding to an uplink bandwidth part.

Aspect 38: The method of any of Aspects 32-37, wherein the FDM uplink shared channel configuration configures a set of potential RB offset values, the method further comprising transmitting a downlink control information (DCI) transmission that indicates a selected RB offset value of the set of potential RB offset values, wherein the selected RB offset value corresponds to the RB offset.

Aspect 39: The method of Aspect 38, wherein the set of potential RB offset values is a frequency hopping RB offset list.

Aspect 40: The method of either of Aspects 38 or 39, wherein the DCI transmission corresponds to a specified DCI format, and wherein the set of potential RB offset values is associated with the specified DCI format.

Aspect 41: The method of Aspect 40, wherein the FDM uplink shared channel configuration comprises an additional set of potential RB offset values associated with the specified DCI format.

Aspect 42: The method of any of Aspects 38-41, wherein the set of potential RB offset values consists of one potential RB offset value, and wherein the one potential RB offset value corresponds to the RB offset.

Aspect 43: The method of any of Aspects 38-41, wherein the set of potential RB offset values consists of a first potential RB offset value and a second potential RB offset value, and wherein a most significant bit, of a plurality of bits of a frequency domain resource allocation (FDRA) field of the DCI transmission, indicates, as the RB offset, the first potential RB offset value or the second potential RB offset value.

Aspect 44: The method of Aspect 43, wherein a set of remaining bits of the FDRA field indicates the first starting RB and a quantity of RBs in the first subset of RBs, the set of remaining bits excluding the most significant bit.

Aspect 45: The method of any of Aspects 38-41, wherein the set of potential RB offset values consists of four potential RB offset values, and wherein a first two most significant bits, of a plurality of bits of a frequency domain resource allocation (FDRA) field of the DCI transmission, indicate a potential RB offset value, of the set of potential RB offset values, as the RB offset.

Aspect 46: The method of Aspect 45, wherein a set of remaining bits of the FDRA field indicates the first starting RB and a quantity of RBs in the first subset of RBs, the set of remaining bits excluding the first two most significant bits.

Aspect 47: The method of any of Aspects 32-46, further comprising transmitting a frequency hopping indication having a specified value, wherein receiving the uplink shared channel signal based at least in part on the FDM uplink shared channel configuration comprises receiving the uplink shared channel signal in accordance with the FDM uplink configuration based at least in part on the frequency hopping indication having the specified value.

Aspect 48: The method of any of Aspects 32-46, further comprising transmitting a frequency hopping indication having a specified value indicating that frequency hopping is enabled, wherein receiving the uplink shared channel signal comprises receiving, based at least in part on the frequency hopping indication having the specified value: a first group of RBs in a first frequency hop, the first group of RBs comprising a first portion of the first subset of RBs and a first portion of the second subset of RBs; and a second group of RBs in a second frequency hop, the second group of RBs comprising a second portion of the first subset of RBs and a second portion of the second subset of RBs.

Aspect 49: The method of Aspect 48, wherein the RB offset comprises a frequency hopping RB offset.

Aspect 50: The method of either of Aspects 48 or 49, wherein the first portion of the first subset of RBs is based at least in part on a ceiling function of a product of one half and a length of the first subset of RBs, and wherein the first portion of the second subset of RBs is based at least in part on a floor function of a product of one half and a length of the second subset of RBs.

Aspect 51: The method of any of Aspects 48-50, wherein the second portion of the first subset of RBs is based at least in part on a ceiling function of a product of one half and a length of the first subset of RBs, and wherein the second portion of the second subset of RBs is based at least in part on a floor function of a product of one half and a length of the second subset of RBs.

Aspect 52: The method of any of Aspects 48-51, wherein the first portion of the first subset of RBs is based at least in part on a ceiling function of a product of one half and a length of the first subset of RBs, and wherein the first portion of the second subset of RBs is based at least in part on a floor function of a product of one half and a length of the second subset of RBs.

Aspect 53: The method of any of Aspects 48-52, wherein the second portion of the first subset of RBs is based at least in part on a floor function of a product of one half and a length of the first subset of RBs, and wherein the second portion of the second subset of RBs is based at least in part on a ceiling function of a product of one half and a length of the second subset of RBs.

Aspect 54: The method of any of Aspects 32-53, wherein frequency hopping is enabled, and wherein receiving the uplink shared channel signal comprises receiving, in a first frequency hop, a first portion of the first subset of RBs and a first portion of the second subset of RBs; and receiving, in a second frequency hop, a second portion of the first subset of RBs and a second portion of the second subset of RBs.

Aspect 55: The method of Aspect 54, further comprising: transmitting a first set of potential RB offset values associated with the RB offset; and transmitting a second set of potential RB offset values associated with a frequency offset between the first frequency hop and the second frequency hop.

Aspect 56: The method of Aspect 55, further comprising transmitting a downlink control information (DCI) transmission including a frequency domain resource allocation (FDRA) field that indicates a first allocation of the first portion of the first subset of RBs associated with the first frequency hop, wherein a quantity of bits of the FDRA field used to indicate the first allocation is based at least in part on a ceiling of a log function of a quantity of RBs in an uplink bandwidth part minus a ceiling of a log function of a quantity of potential RB offset values in the first set of potential RB offset values minus a ceiling of a log function of a quantity of potential RB offset values in the second set of potential RB offset values.

Aspect 57: The method of either of Aspects 55 or 56, wherein a quantity of RBs in the first portion of the first subset of RBs equals a quantity of RBs in the first portion of the second subset of RBs.

Aspect 58: The method of any of Aspects 55-57, further comprising transmitting a downlink control information (DCI) transmission including a frequency domain resource allocation (FDRA) field that indicates a first selected RB offset value of the first set of potential RB offset values, and wherein a first quantity of bits of the FDRA field used to indicate the first selected RB offset value is based at least in part on a ceiling function of a log function of a quantity of potential RB offset values of the first set of potential RB values.

Aspect 59: The method of Aspect 58, wherein a second starting RB associated with the first portion of the second subset of RBs is based at least in part on a modulo function of a sum of the first starting RB and the first selected RB offset value.

Aspect 60: The method of either of Aspects 58 or 59, wherein a third starting RB associated with the second portion of the first subset of RBs is based at least in part on a modulo function of a sum of the first starting RB and a second selected RB offset value of the second set of potential RB values.

Aspect 61: The method of Aspect 60, wherein a second quantity of bits of the FDRA field used to indicate the second selected RB offset value is based at least in part on a ceiling function of a log function of a quantity of potential RB offset values in the second set of potential RB offset values.

Aspect 62: The method of Aspect 61, wherein a fourth starting RB associated with the second portion of the second subset of RBs is based at least in part on a modulo function of a sum of the first starting RB, the first selected RB offset value, and the second selected RB offset value.

Aspect 63: An apparatus for wireless communication at a device, comprising a processor; memory coupled with the processor; and instructions stored in the memory and executable by the processor to cause the apparatus to perform the method of one or more of Aspects 1-31.

Aspect 64: A device for wireless communication, comprising a memory and one or more processors coupled to the memory, the one or more processors configured to perform the method of one or more of Aspects 1-31.

Aspect 65: An apparatus for wireless communication, comprising at least one means for performing the method of one or more of Aspects 1-31.

Aspect 66: A non-transitory computer-readable medium storing code for wireless communication, the code comprising instructions executable by a processor to perform the method of one or more of Aspects 1-31.

Aspect 67: A non-transitory computer-readable medium storing a set of instructions for wireless communication, the set of instructions comprising one or more instructions that, when executed by one or more processors of a device, cause the device to perform the method of one or more of Aspects 1-31.

Aspect 68: An apparatus for wireless communication at a device, comprising a processor; memory coupled with the processor; and instructions stored in the memory and executable by the processor to cause the apparatus to perform the method of one or more of Aspects 32-62.

Aspect 69: A device for wireless communication, comprising a memory and one or more processors coupled to the memory, the one or more processors configured to perform the method of one or more of Aspects 32-62.

Aspect 70: An apparatus for wireless communication, comprising at least one means for performing the method of one or more of Aspects 32-62.

Aspect 71: A non-transitory computer-readable medium storing code for wireless communication, the code comprising instructions executable by a processor to perform the method of one or more of Aspects 32-62.

Aspect 72: A non-transitory computer-readable medium storing a set of instructions for wireless communication, the set of instructions comprising one or more instructions that, when executed by one or more processors of a device, cause the device to perform the method of one or more of Aspects 32-62.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving a frequency division multiplexing (FDM) uplink shared channel configuration associated with a resource block (RB) partitioning scheme for partitioning a set of allocated RBs into a first subset of RBs and a second subset of RBs, wherein the second subset of RBs is associated with an RB offset corresponding to a first starting RB, the first starting RB comprising an RB of the first subset of RBs having a lowest frequency value of a plurality of frequency values corresponding to the first subset of RBs; and
transmitting an uplink shared channel signal based at least in part on the FDM uplink shared channel configuration.

2. The method of claim 1, further comprising receiving a downlink control information (DCI) transmission comprising a frequency domain resource allocation (FDRA) field that indicates the set of RBs.

3. The method of claim 2, wherein the FDRA field indicates the first starting RB and a first quantity of RBs included in the first subset of RBs, wherein the second subset of RBs includes a second quantity of RBs, and wherein the second quantity of RBs matches the first quantity of RBs.

4. The method of claim 1, further comprising determining a second starting RB based at least in part on a modulo function of a sum of the first starting RB and the RB offset, wherein the second starting RB comprises an RB of the second subset of RBs having a lowest frequency value of a plurality of frequency values corresponding to the second subset of RBs, and wherein the modulo function includes a modulus equal to a quantity of RBs corresponding to an uplink bandwidth part.

5. The method of claim 1, wherein the FDM uplink shared channel configuration configures a set of potential RB offset values, the method further comprising receiving a downlink control information (DCI) transmission that indicates a selected RB offset value of the set of potential RB offset values, wherein the selected RB offset value corresponds to the RB offset.

6. The method of claim 5, wherein the set of potential RB offset values is a frequency hopping RB offset list.

7. The method of claim 5, wherein the DCI transmission corresponds to a specified DCI format, and wherein the set of potential RB offset values is associated with the specified DCI format.

8. The method of claim 5, wherein the set of potential RB offset values consists of one potential RB offset value, and wherein the one potential RB offset value corresponds to the RB offset.

9. The method of claim 5, wherein the set of potential RB offset values consists of a first potential RB offset value and a second potential RB offset value, and wherein a most significant bit, of a plurality of bits of a frequency domain resource allocation (FDRA) field of the DCI transmission, indicates, as the RB offset, the first potential RB offset value or the second potential RB offset value.

10. The method of claim 9, wherein a set of remaining bits of the FDRA field indicates the first starting RB and a quantity of RBs in the first subset of RBs, the set of remaining bits excluding the most significant bit.

11. The method of claim 5, wherein the set of potential RB offset values consists of four potential RB offset values, wherein a first two most significant bits, of a plurality of bits of a frequency domain resource allocation (FDRA) field of the DCI transmission, indicate a potential RB offset value, of the set of potential RB offset values, as the RB offset, and wherein a set of remaining bits of the FDRA field indicates the first starting RB and a quantity of RBs in the first subset of RBs, the set of remaining bits excluding the first two most significant bits.

12. The method of claim 1, further comprising receiving a frequency hopping indication having a specified value, wherein transmitting the uplink shared channel signal based at least in part on the FDM uplink shared channel configuration comprises applying the FDM uplink configuration based at least in part on the frequency hopping indication having the specified value.

13. The method of claim 1, further comprising receiving a frequency hopping indication having a specified value indicating that frequency hopping is enabled, wherein transmitting the uplink shared channel signal comprises transmitting, based at least in part on the frequency hopping indication having the specified value:
a first group of RBs in a first frequency hop, the first group of RBs comprising a first portion of the first subset of RBs and a first portion of the second subset of RBs; and
a second group of RBs in a second frequency hop, the second group of RBs comprising a second portion of the first subset of RBs and a second portion of the second subset of RBs.

14. The method of claim 13, wherein the RB offset comprises a frequency hopping RB offset.

15. The method of claim 13, wherein the first portion of the first subset of RBs is based at least in part on a ceiling function of a product of one half and a length of the first subset of RBs, and wherein the first portion of the second subset of RBs is based at least in part on a floor function of a product of one half and a length of the second subset of RBs.

16. The method of claim 13, wherein the second portion of the first subset of RBs is based at least in part on a ceiling function of a product of one half and a length of the first subset of RBs, and wherein the second portion of the second subset of RBs is based at least in part on a floor function of a product of one half and a length of the second subset of RBs.

17. The method of claim 13, wherein the first portion of the first subset of RBs is based at least in part on a ceiling function of a product of one half and a length of the first subset of RBs, and wherein the first portion of the second subset of RBs is based at least in part on a floor function of a product of one half and a length of the second subset of RBs.

18. The method of claim 13, wherein the second portion of the first subset of RBs is based at least in part on a floor function of a product of one half and a length of the first subset of RBs, and wherein the second portion of the second subset of RBs is based at least in part on a ceiling function of a product of one half and a length of the second subset of RBs.

19. The method of claim 1, wherein frequency hopping is enabled, and wherein transmitting the uplink shared channel signal comprises transmitting, in a first frequency hop, a first portion of the first subset of RBs and a first portion of the second subset of RBs; and
transmitting, in a second frequency hop, a second portion of the first subset of RBs and a second portion of the second subset of RBs.

20. The method of claim 19, further comprising:
receiving a first set of potential RB offset values associated with the RB offset; and
receiving a second set of potential RB offset values associated with a frequency offset between the first frequency hop and the second frequency hop.

21. The method of claim 20, further comprising receiving a downlink control information (DCI) transmission including a frequency domain resource allocation (FDRA) field that indicates a first allocation of the first portion of the first subset of RBs associated with the first frequency hop, wherein a quantity of bits of the FDRA field used to indicate the first allocation is based at least in part on a ceiling of a log function of a quantity of RBs in an uplink bandwidth part minus a ceiling of a log function of a quantity of potential RB offset values in the first set of potential RB offset values minus a ceiling of a log function of a quantity of potential RB offset values in the second set of potential RB offset values.

22. The method of claim 20, wherein a quantity of RBs in the first portion of the first subset of RBs equals a quantity of RBs in the first portion of the second subset of RBs.

23. The method of claim 20, further comprising receiving a downlink control information (DCI) transmission including a frequency domain resource allocation (FDRA) field that indicates a first selected RB offset value of the first set of potential RB offset values, wherein a first quantity of bits of the FDRA field used to indicate the first selected RB offset value is based at least in part on a ceiling function of a log function of a quantity of potential RB offset values of the first set of potential RB values, and wherein a second starting RB associated with the first portion of the second subset of RBs is based at least in part on a modulo function of a sum of the first starting RB and the first selected RB offset value.

24. The method of claim 23, wherein a third starting RB associated with the second portion of the first subset of RBs is based at least in part on a modulo function of a sum of the first starting RB and a second selected RB offset value of the second set of potential RB values, wherein a second quantity of bits of the FDRA field used to indicate the second selected RB offset value is based at least in part on a ceiling function of a log function of a quantity of potential RB offset values in the second set of potential RB offset values, and wherein a fourth starting RB associated with the second portion of the second subset of RBs is based at least in part on a modulo function of a sum of the first starting RB, the first selected RB offset value, and the second selected RB offset value.

25. A method of wireless communication performed by a network node, comprising:
transmitting a frequency division multiplexing (FDM) uplink shared channel configuration associated with a resource block (RB) partitioning scheme for partitioning a set of allocated RBs into a first subset of RBs and a second subset of RBs, wherein the second subset of RBs is associated with an RB offset corresponding to a first starting RB, the first starting RB comprising an RB of the first subset of RBs having a lowest frequency value of a plurality of frequency values corresponding to the first subset of RBs; and
receiving an uplink shared channel signal based at least in part on the FDM uplink shared channel configuration.

26. The method of claim 25, further comprising transmitting a frequency hopping indication having a specified value, wherein receiving the uplink shared channel signal based at least in part on the FDM uplink shared channel configuration comprises receiving the uplink shared channel signal in accordance with the FDM uplink configuration based at least in part on the frequency hopping indication having the specified value.

27. A user equipment (UE) for wireless communication, comprising:
a memory; and
one or more processors coupled to the memory and configured to cause the UE to:
receive a frequency division multiplexing (FDM) uplink shared channel configuration associated with a resource block (RB) partitioning scheme for partitioning a set of allocated RBs into a first subset of RBs and a second subset of RBs, wherein the second subset of RBs is associated with an RB offset corresponding to a first starting RB, the first starting RB comprising an RB of the first subset of RBs having a lowest frequency value of a plurality of frequency values corresponding to the first subset of RBs; and
transmit an uplink shared channel signal based at least in part on the FDM uplink shared channel configuration.

28. The UE of claim 27, wherein the one or more processors are further configured to cause the UE to receive a frequency hopping indication having a specified value, wherein the one or more processors, to cause the UE to transmit the uplink shared channel signal based at least in part on the FDM uplink shared channel configuration, are configured to cause the UE to apply the FDM uplink configuration based at least in part on the frequency hopping indication having the specified value.

29. A network node for wireless communication, comprising:
a memory; and
one or more processors coupled to the memory and configured to cause the network node to:
transmit a frequency division multiplexing (FDM) uplink shared channel configuration associated with a resource block (RB) partitioning scheme for partitioning a set of allocated RBs into a first subset of RBs and a second subset of RBs, wherein the second subset of RBs is associated with an RB offset corresponding to a first starting RB, the first starting RB comprising an RB of the first subset of RBs having a lowest frequency value of a plurality of frequency values corresponding to the first subset of RBs; and
receive an uplink shared channel signal based at least in part on the FDM uplink shared channel configuration.

30. The network node of claim 29, wherein the one or more processors are further configured to cause the network node to transmit a frequency hopping indication having a specified value, and wherein the one or more processors, to cause the network node to receive the uplink shared channel signal based at least in part on the FDM uplink shared channel configuration, are configured to cause the network node to receive the uplink shared channel signal in accordance with the FDM uplink configuration based at least in part on the frequency hopping indication having the specified value.
